(19) United States
(12) Patent Application Publication
(10) Pub. No.: US 2025/0192874 A1
(43) Pub. Date: Jun. 12, 2025

(54) ELECTRONIC DEVICE, TERMINAL DEVICE, NON-TERRESTRIAL BASE STATION, AND METHOD

(71) Applicant: Sony Group Corporation, Tokyo (JP)

(72) Inventors: Hiroki MATSUDA, Saitama (JP); Kazuyuki SHIMEZAWA, Kanagawa (JP); Hiromasa UCHIYAMA, Tokyo (JP); Naoki KUSASHIMA, Tokyo (JP); Ren SUGAI, Kanagawa (JP)

(73) Assignee: Sony Group Corporation, Tokyo (JP)

(21) Appl. No.: 18/844,398

(22) PCT Filed: Apr. 7, 2023
(86) PCT No.: PCT/JP2023/014378

§ 371 Date: Sep. 6, 2024

(30) Foreign Application Priority Data
Apr. 22, 2022 (JP) 2022-071122

(51) Int. Cl. H04B 7/185

(52) U.S. Cl. CPC H04B 7/18513; H04B 7/18541

(57) ABSTRACT

An electronic device comprising circuitry configured to receive, from a first non-terrestrial base station, terrestrial communication information for performing terrestrial communication outside of a coverage area of the first non-terrestrial base station; receive, from the first non-terrestrial base station, non-terrestrial communication information for performing non-terrestrial communication with the first non-terrestrial base station or a second non-terrestrial base station; perform the terrestrial communication using the terrestrial communication information in a case that the electronic device moves from inside to outside the coverage area of the first non-terrestrial base station; and perform the non-terrestrial communication using the non-terrestrial communication information in a case that the electronic device moves from outside to inside the coverage area of the first non-terrestrial base station or from outside to inside a coverage area of the second non-terrestrial base station.

### TECHNICAL FIELD

The present disclosure relates to a terminal device, a base station device, and a communication method.

### BACKGROUND ART

Radio access schemes and wireless networks for cellular mobile communication (hereinafter, also referred to as “Long Term Evolution (LTE)”, “LTE-Advanced (LTE-A)”, “LTE-Advanced Pro (LTE-A Pro)”, “New Radio (NR)”, “New Radio Access Technology (NRAT)”, “Evolved Universal Terrestrial Radio Access (EUTRA)”, or “Further EUTRA (FEUTRA)”) have been studied in the 3rd Generation Partnership Project (3GPP (registered trademark)). Note that, in the following explanation, LTE includes LTE-A, LTE-A Pro, and EUTRA and NR includes NRAT and FEUTRA. In LTE, a base station device (a base station) is also referred to as eNodeB (evolved NodeB), in NR, a base station device (a base station) is also referred to as gNodeB, and in LTE and NR, a terminal device (a mobile station, a mobile station device, and a terminal) is also referred to as UE (User Equipment). LTE and NR arc cellular communication systems in which a plurality of areas covered by a base station device are arranged in a cell shape. A single base station device may manage a plurality of cells.

NR is an RAT (Radio Access Technology) different from LTE as a next-generation radio access scheme for LTE. NR is an access technology that can cope with various use cases including eMBB (Enhanced mobile broadband), mMTC (Massive machine type communications), and URLLC (Ultra reliable and low latency communications). NR is capable of implementing a technical framework adapted to usage scenarios, requirements, displacement scenarios, and the like in those use cases.

Further, in the NR, studies on a non-terrestrial network (NTN) in which a wireless network is provided from a device floating in the air or the space have started according to an increase in requests for wide area coverage, connection stability, and the like. In the non-terrestrial network, a wireless network is provided to a terminal device via a satellite station or an aircraft. In the non-terrestrial network, integrated operation between the terrestrial network and the non-terrestrial network is facilitated by using the same radio access scheme as that of the terrestrial network.

Since the non-terrestrial network has a wider coverage than the terrestrial network, it is very effective to cover, with the non-terrestrial network, an area that cannot be covered by the terrestrial network. For example, V2X (Vehicle-to-X) communication is conceivable as one of use cases. In the V2X communication, since a communication error directly leads to an accident, highly reliable communication is required compared with the other use cases. As explained above, in an area outside the coverage of the terrestrial network, it is conceivable to provide communication coverage with a non-terrestrial network such as satellite communication. Since the non-terrestrial network has a longer radio wave propagation distance compared with communication with the terrestrial network, communication quality becomes relatively poor. Therefore, when non-line of sight communication occurs between the base station and the terminal, it is difficult to continue the communication. For example, when a car enters a tunnel or the like, there is a high possibility that communication with the non-terrestrial network cannot be continued. However, the V2X communication is sometimes used in driving control and the like. Unexpected disconnection of communication is a major problem in safety.

In relation to a discontinuous coverage environment of the non-terrestrial network, Non-Patent Literature 1 studies a technology for achieving power saving of an Internet of Things (IoT) terminal in a discontinuous coverage environment of a non-terrestrial network in communication between the IoT terminal and satellite communication.

### CITATION LIST

### Non Patent Literature

NPL 1: R2-2110834, Ericsson, “Discontinuous coverage in IoT NTN”, 3GPP TSGRAN WG2 Meeting #116-e E-meeting, 1-12 Nov. 2021, [Online], [Searched on Apr. 13, 2022], Internet<https://www.3gpp.org/ftp/TSG_RAN/WG2_RL2/TSGR2_116-c/Docs/R2-21 10843.zip>

### SUMMARY OF INVENTION

### Technical Problem

In NPL 1, studies have been made for the purpose of power saving of the IoT terminal in the discontinuous coverage environment of the non-terrestrial network. However, in NPL 1, improvement of reliability outside the coverage of the non-terrestrial network has not been studied. Therefore, in use cases requiring reliability such as V2X communication, a technology for improving reliability in a discontinuous coverage environment of a non-terrestrial network is desired.

Therefore, the present disclosure proposes a mechanism that can further improve reliability outside the coverage of a non-terrestrial network.

Note that the above problem or object is merely one of a plurality of problems or objects that can be solved or achieved by a plurality of embodiments disclosed in the present specification.

### Solution to Problem

The present disclosure is directed to an electronic device comprising: circuitry configured to receive, from a first non-terrestrial base station, terrestrial communication information for performing terrestrial communication outside of a coverage area of the first non-terrestrial base station; receive, from the first non-terrestrial base station, non-terrestrial communication information for performing non-terrestrial communication with the first non-terrestrial base station or a second non-terrestrial base station; perform the terrestrial communication using the terrestrial communication information in a case that the electronic device moves from inside to outside the coverage area of the first non-terrestrial base station; and perform the non-terrestrial communication using the non-terrestrial communication information in a case that the electronic device moves from outside to inside the coverage area of the first non-terrestrial base station or from outside to inside a coverage area of the second non-terrestrial base station.

### BRIEF DESCRIPTION OF DRAWINGS

FIG. 1 is a diagram illustrating a configuration example of a communication system according to an embodiment of the present disclosure.

FIG. 2 is a diagram illustrating an example of a wireless network provided by the communication system.

FIG. 3 is a diagram illustrating an overview of satellite communication provided by the communication system.

FIG. 4 is a diagram illustrating an example of a cell configured by a nongeostationary satellite.

FIG. 5 is a diagram illustrating a configuration example of a management device according to the embodiment of the present disclosure.

FIG. 6 is a diagram illustrating a configuration example of a ground station according to the embodiment of the present disclosure.

FIG. 7 is a diagram illustrating a configuration example of a satellite station according to the embodiment of the present disclosure.

FIG. 8 is a diagram illustrating a configuration example of a terminal device according to the embodiment of the present disclosure.

FIG. 9 is a sequence chart for explaining an example of a handover flow.

FIG. 10 is a sequence chart for explaining another example of the handover flow.

FIG. 11 is a diagram for explaining an example of a first case of the communication system according to the embodiment of the present disclosure.

FIG. 12 is a diagram for explaining another example of the first case of the communication system according to the embodiment of the present disclosure.

FIG. 13 is a diagram for explaining another example of the first case of the communication system according to the embodiment of the present disclosure.

FIG. 14 is a diagram for explaining an example of communication by the communication system according to the embodiment of the present disclosure.

FIG. 15 is a sequence chart illustrating an example of a flow of terminal information notification processing according to the embodiment of the present disclosure.

FIG. 16 is a sequence chart illustrating another example of the flow of the terminal information notification processing according to the embodiment of the present disclosure.

FIG. 17 is a sequence chart illustrating an example of a flow of handover processing according to the embodiment of the present disclosure.

FIG. 18 is a diagram for explaining another example of the communication by the communication system according to the embodiment of the present disclosure.

FIG. 19 is a diagram for explaining an example of a second case of the communication system according to the embodiment of the present disclosure.

FIG. 20 is a sequence chart illustrating an example of a flow of movement processing according to the embodiment of the present disclosure.

FIG. 21 is a diagram for explaining another example of the second case of the communication system according to the embodiment of the present disclosure.

FIG. 22 is a sequence chart illustrating an example of a flow of movement processing according to the embodiment of the present disclosure.

### DESCRIPTION OF EMBODIMENTS

An embodiment of the present disclosure is explained in detail below with reference to the accompanying drawings. Note that, in the present specification and the drawings, components having substantially the same functional configurations are denoted by the same reference numerals and signs, whereby redundant explanation of the components is omitted.

In the present specification and the drawings, a plurality of components having substantially the same functional configuration are sometimes distinguished by attaching different numbers or alphabets after the same reference numeral. For example, a plurality of components having substantially the same functional configuration are distinguished as terminal devices 40₁, 40₂, and 40₃ according to necessity. However, when it is not particularly necessary to distinguish each of a plurality of components having substantially the same functional configuration, only the same reference numeral is added. For example, when it is unnecessary to particularly distinguish the terminal devices 40₁, 40₂, and 40₃, the terminal devices 40₁, 40₂, and 40₃ are simply referred to as terminal devices 40.

In the present specification and the drawings, specific values are sometimes indicated and explained, However, the values are examples, and other values may be applied.

Resources in the present specification and the drawings represent Frequency, Time, Resource Element (including REG, CCE, and CORESET), Resource Block, Bandwidth Part, Component Carrier, Symbol, Sub-Symbol, Slot, Mini-Slot, Subslot, Subframe, Frame, PRACH occasion, Occasion, Code, Multi-access physical resource, Multi-access signature, Subcarrier Spacing (Numerology), and the like.

One or a plurality of embodiments (including examples and modifications) explained below can be respectively implemented independently. On the other hand, at least a part of the plurality of embodiments explained below may be combined with at least a part of other embodiments as appropriate. These plurality of embodiments can include new characteristics different from one another. Therefore, these plurality of embodiments can contribute to solving objects or problems different from one another and can achieve different effects.

### 1. OVERVIEW

A radio access technology (RAT) such as LTE (Long Term Evolution) and NR (New Radio) has been studied in 3GPP (registered trademark). LTE and NR are types of a cellular communication technology and enable mobile communication of a terminal device by arranging a plurality of areas covered by a base station in a cell shape. At this time, a single base station may manage a plurality of cells.

Note that, in the following explanation, it is assumed that “LTE” includes LTE-A (LTE-Advanced), LTE-A Pro (LTE-Advanced Pro), and EUTRA (Evolved Universal Terrestrial Radio Access). NR includes NRAT (New Radio Access Technology) and FEUTRA (Further EUTRA). Note that a single base station may manage a plurality of cells. In the following explanation, a cell adapted to LTE is referred to as LTE cell and a cell adapted to NR is referred to as NR cell.

NR is a next generation (fifth generation) radio access technology (RAT) of LTE. NR is a radio access technology that can cope with various use cases including cMBB (Enhanced Mobile Broadband), mMTC (Massive Machine Type Communications), and URLLC (Ultra-Reliable Low Latency Communications). NR has been studied aiming at a technical framework adapted to usage scenarios, requirement conditions, arrangement scenarios, and the like in these use cases.

Further, in NR, studies on non-terrestrial networks have been started according to an increase in requests for wide area coverage, connection stability, and the like. In a non-terrestrial network, a wireless network is planned to be provided to a terminal device via a base station other than a ground station such as a satellite station or an aircraft station. The base station other than the ground station is referred to as non-ground station or non-ground base station. A wireless network provided by the ground station is referred to as a terrestrial network (TN). By using the same radio access scheme for the terrestrial network and the non-terrestrial network, integrated operation of the terrestrial network and the non-terrestrial network becomes possible.

As explained above, for example, in the V2X communication, since a communication error directly leads to an accident, highly reliable communication is requested compared with other use cases. As explained above, it is conceivable to provide communication coverage with a non-terrestrial network such as satellite communication in an area outside the coverage of the terrestrial network.

On the other hand, since the non-terrestrial network has a longer radio wave propagation distance than the communication with the terrestrial network, communication quality becomes relatively poor. Therefore, when non-line of sight communication occurs between the non-ground base station and the terminal, it is difficult to continue the communication. For example, when a car enters a tunnel or the like, there is a high possibility that communication with the non-terrestrial network cannot be continued. However, the V2X communication is sometimes used in driving control and the like. Unexpected disconnection of communication is a major problem in safety.

Therefore, in use cases requiring reliability of the V2X communication and the like, a technology for the purpose of improving reliability in a discontinuous coverage environment of the non-terrestrial network is requested.

Therefore, in the present embodiment, this request is solved by the following means.

For example, the terminal device of the present embodiment is a terminal device that performs satellite communication between the terminal device and a non-ground base station device. The terminal device acquires, from the non-ground base station device, non-satellite communication information for performing non-satellite communication outside the coverage of the non-ground base station device. The terminal device performs non-satellite communication by using the non-satellite communication information when moving from the inside of the coverage to the outside of the coverage of the non-ground base station device.

Consequently, the terminal device can smoothly perform non-satellite communication outside the coverage of the non-ground base station device. Therefore, the terminal device can further improve reliability of communication in the discontinuous coverage environment of the non-terrestrial network.

Although the overview of the present embodiment is explained above, the communication system according to the present embodiment is explained in detail below.

### 2. CONFIGURATION OF THE COMMUNICATION SYSTEM

A communication system 1 is a Bent-pipe (Transparent) type mobile satellite communication system. The communication system 1 is a cellular communication system using a radio access technology such as LTE or NR and provides wireless communication via a satellite station to a terminal device on the ground. A radio access scheme used by the communication system 1 is not limited to LTE and NR and may be another radio access scheme such as W-CDMA (Wideband Code Division Multiple Access) or cdma 2000 (Code Division Multiple Access 2000).

A configuration of the communication system 1 is specifically explained below.

### <2.1. Overall Configuration of the Communication System>

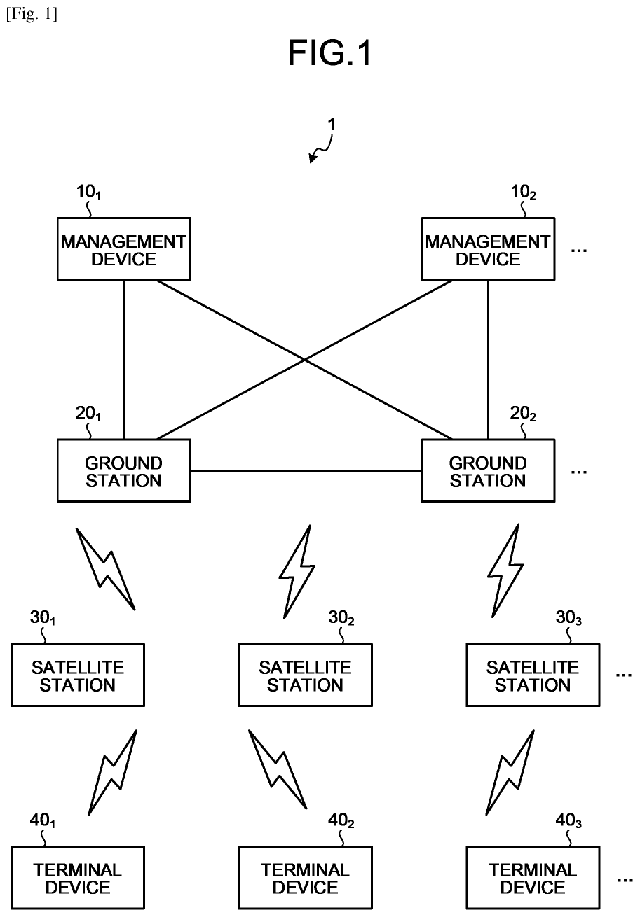

FIG. 1 is a diagram illustrating a configuration example of a communication system 1 according to an embodiment of the present disclosure. The communication system 1 includes a management device 10, a ground station 20, a satellite station 30, and a terminal device 40. Wireless communication devices configuring the communication system 1 operate in cooperation, whereby the communication system 1 provides a user with a wireless network capable of performing mobile communication. The wireless network in the present embodiment is configured by, for example, a radio access network and a core network. Note that, in the present embodiment, the wireless communication device is a device having a function of wireless communication, in the example illustrated in FIG. 1, the ground station 20, the satellite station 30, and the terminal device 40 correspond to the wireless communication device.

The communication system 1 may include a plurality of management devices 10, a plurality of ground stations 20, a plurality of satellite stations 30, and a plurality of terminal devices 40. In the example illustrated in FIG. 1, the communication system 1 includes management devices 10₁, 10₂ and the like as the management device 10 and includes ground stations 20₁, 20₂ and the like as the ground station 20. The communication system 1 includes satellite stations 30₁, 30₂ and the like as the satellite station 30 and includes terminal devices 40₁, 40₂, 40₃ and the like as the terminal device 40.

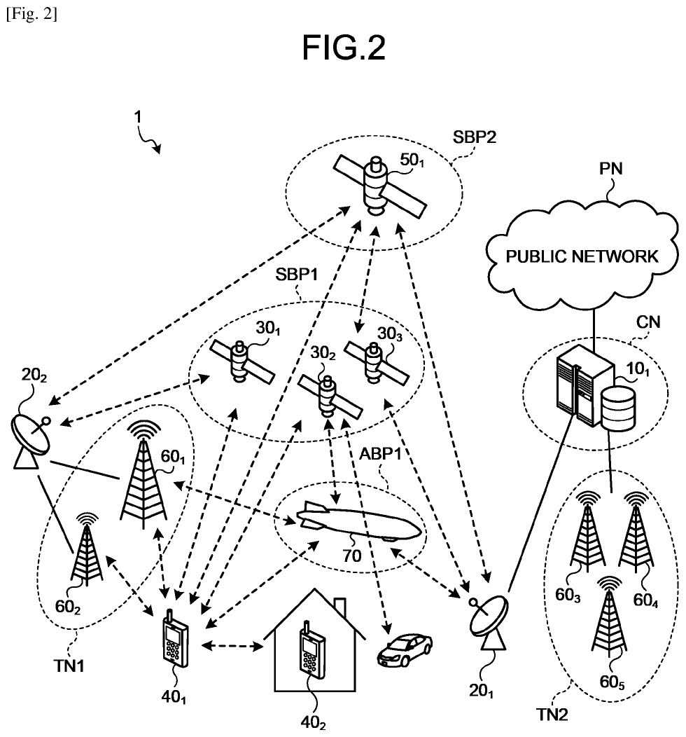

FIG. 2 is a diagram illustrating an example of a wireless network provided by the communication system 1. The ground station 20 (the satellite station 30) and a base station 60 configure a cell. A cell is an area where wireless communication is covered. The cell may be any of a macro cell, a micro cell, a femto cell, and a small cell. Note that the communication system 1 may be configured to manage a plurality of cells with a single base station (satellite station) or may be configured to manage one cell with a plurality of base stations.

In the example illustrated in FIG. 2, base stations 60₁ and 60₂ configure a terrestrial network TN1 and base stations 60₃, 60₄, and 60₅ configure a terrestrial network TN2. The terrestrial network TN1 and the terrestrial network TN2 are, for example, networks operated by a wireless communication carrier such as a telephone company.

The terrestrial network TN1 and the terrestrial network TN2 may be operated by different wireless communication carriers or may be operated by the same wireless communication carrier. The terrestrial network TN1 and the terrestrial network TN2 can be regarded as one terrestrial network.

The terrestrial network TN1 and the terrestrial network TN2 are respectively connected to core networks. In the example illustrated in FIG. 2, the base station 60 configuring the terrestrial network TN2 is connected to, for example, a core network CN configured by the management device 10₁ and the like. If a radio access scheme of the terrestrial network TN2 is LTE, the core network CN is EPC. If the radio access scheme of the terrestrial network TN2 is NR, the core network CN is 5GC. Naturally, the core network CN is not limited to EPC or 5GC and may be a core network of another radio access scheme. In the example illustrated in FIG. 2, the terrestrial network TN1 is not connected to a core network. However, the terrestrial network TN1 may be connected to the core network CN. The terrestrial network TN1 may be connected to a not-illustrated core network different from the core network CN.

The core network CN includes a gateway device, a gate exchange, and the like and is connected to a public network PN via a gateway device. The public network PN is a public data network such as the Internet, a regional IP network, or a telephone network (a mobile telephone network, a fixed telephone network, or the like). The gateway device is a server device connected to the Internet, a regional IP network, or the like. The gate exchange is, for example, an exchange connected to a telephone network of a telephone company. The management device 10₁ may have a function of the gateway device or the gate exchange.

All of the satellite stations 30 and 50 and an aircraft station 70 illustrated in FIG. 2 are non-ground stations such as a satellite station and an aircraft station. A satellite station group (or a satellite station) configuring the non-terrestrial network is referred to as a spaceborne platform. In addition, an aircraft station group (or an aircraft station) configuring the non-terrestrial network is referred to as an airborne platform. In the example illustrated in FIG. 2, the satellite stations 30₁, 30₂, and 30₃ configure a spaceborne platform SBP1 and a satellite station 50₁ configures a spaceborne platform SBP2. An aircraft station 70 configures an airborne platform ABP1.

The terminal device 40 is capable of communicating with both the ground station and the non-ground station. In the example illustrated in FIG. 2, the terminal device 40₁ is capable of communicating with a ground station configuring the terrestrial network TN1. The terminal device 40₁ is capable of communicating with the non-ground stations configuring the spaceborne platforms SBP1 and SBP2. The terminal device 40₁ is also capable of communicating with a non-ground station configuring the airborne platform ABP1. Note that the terminal device 40₁ may be capable of directly communicating with another terminal device 40 (the terminal device 40₂ in the example illustrated in FIG. 2). The terminal device 40₃ is capable of communicating with a non-ground station configuring the spaceborne platform SBP1.

The non-ground station such as the satellite station 30 may be connectable to a terrestrial network or a core network via a relay station. The non-ground stations can directly communicate with each other not via the relay station.

The relay station is, for example, an aircraft station or an earth station. The aircraft station is a wireless station installed on the ground or a mobile body moving on the ground in order to communicate with an aircraft station. The earth station is a wireless station located on the earth (including the air) in order to communicate with a satellite station (a space station). The earth station may be a large earth station or may be a small earth station such as a VSAT (Very Small Aperture Terminal). Note that the earth station may be a VSAT controlled earth station (also referred to as master station or HUB station) or a VSAT earth station (also referred to as slave station). The earth station may be a wireless station installed in a mobile body moving on the ground. Examples of an earth station loaded on a ship include earth stations on board vessels (ESV). The earth station may include an aircraft earth station that is installed in an aircraft (including a helicopter) and communicates with a satellite station. The earth station may include an aeronautical earth station that is installed in a mobile body moving on the ground and communicates with the aircraft earth station via a satellite station. Note that the relay station may be a portable movable wireless station that communicates with a satellite station or an aircraft station. The relay station can be regarded as a part of the communication system 1.

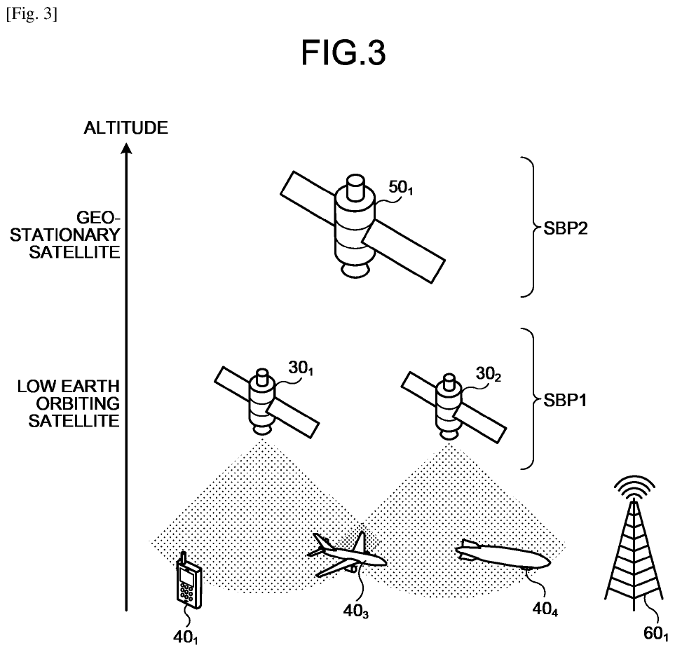

Devices configuring the spaceborne platforms SBP1 and SBP2 perform satellite communication with the terminal device 40. Satellite communication means wireless communication between a satellite station and a communication device. FIG. 3 is a diagram illustrating an overview of satellite communication provided by the communication system 1. The satellite station is mainly divided into a geostationary satellite station and a low earth orbiting satellite station.

The geostationary satellite station is located at an altitude of approximately 35786 km and revolves the earth at the same speed as the rotation speed of the earth. In the example illustrated in FIG. 3, the satellite station 50₁ configuring the spaceborne platform SBP2 is a geostationary satellite station. Relative velocity of the geostationary satellite station to the terminal device 40 on the ground is substantially 0. The geostationary satellite station is observed as if standing still from the terminal device 40 on the ground. The satellite station 50₁ performs satellite communication with terminal devices 40₁, 40₃, 40₄, and the like located on the earth.

The low earth orbiting satellite station is a satellite station that orbits at lower altitude than the geostationary satellite station or a middle earth orbiting satellite station. The low earth orbiting satellite station is, for example, a satellite station located at altitude of 500 km to 2000 km. In the example illustrated in FIG. 3, the satellite station 30₂ and the satellite station 30₃ configuring the spaceborne platform SBP1 are low earth orbiting satellite stations. Note that FIG. 3 illustrates only two satellite stations, namely, the satellite station 30₂ and the satellite station 30₃ as satellite stations configuring the spaceborne platform SBP1. However, actually, in the satellite stations configuring the spaceborne platform SBP1, a low earth orbiting satellite constellation is formed by two or more (for example, several ten to several thousand) satellite stations 30. Unlike the geostationary satellite station, the low earth orbiting satellite station has relative velocity to the terminal device 40 on the ground and is observed as if moving from the terminal device 40 on the ground. The satellite stations 30₂ and 30₃ respectively configure cells and perform satellite communication with the terminal devices 40₁, 40₃, 40₄, and the like located on the earth.

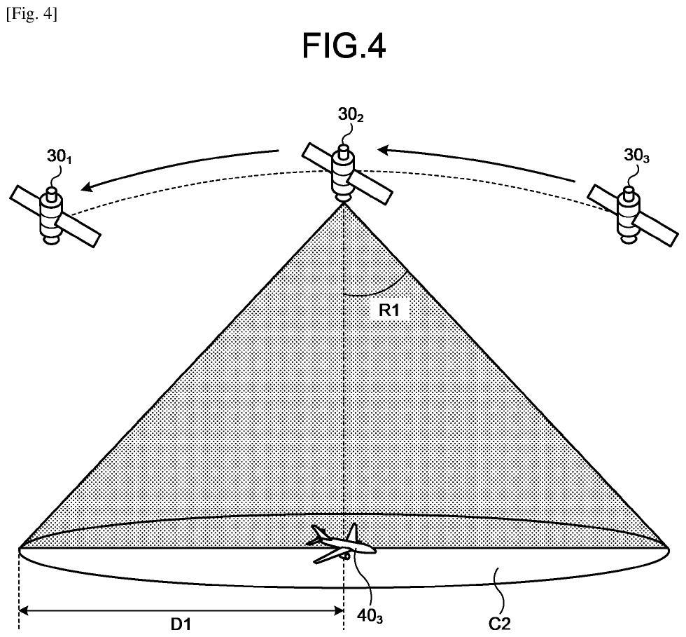

FIG. 4 is a diagram illustrating an example of a cell configured by a nongeostationary satellite. FIG. 4 illustrates a cell C2 formed by the satellite station 30₂ that is a low earth orbiting satellite station. A satellite station orbiting in a low orbit communicates with the terminal device 40 on the ground with predetermined directivity on the ground. For example, an angle R1 illustrated in FIG. 4 is 40°. In the case of FIG. 4, a radius D1 of the cell C2 formed by the satellite station 30₂ is, for example, 1000 km. The low earth orbiting satellite station moves with constant velocity. When it becomes difficult for the low earth orbiting satellite station to provide satellite communication to the terminal device 40 on the ground, the following low earth orbiting satellite station (neighbor satellite station) provides satellite communication. In the case of the example illustrated in FIG. 4, when it becomes difficult for the satellite station 30₂ to provide satellite communication to the terminal device 40 on the ground, the following satellite station 30; provides satellite communication. Note that the values of the angle R1 and the radius D1 described above are merely examples and are not limited to the above.

As explained above, the middle earth orbiting satellite and the low earth orbiting satellite are moving on orbits at extremely high speed in the sky and, for example, a low earth orbiting satellite present at altitude of 600 km is moving on an orbit at speed of 7.6 km/S. The low earth orbiting satellite forms a cell (or a beam) having a radius of several 10 km to several 100 km on the ground. However, since the cell formed on the ground also moves according to the movement of the satellite, handover is sometimes necessary even if the terminal device 40 on the ground is not moving. For example, assuming a case in which a cell diameter formed on the ground is 50 km and the terminal device 40 on the ground is not moving, handover occurs in about 6 to 7 seconds.

As explained above, the terminal device 40 is capable of performing wireless communication using a non-terrestrial network. The satellite station 30 of the communication system 1 configures a non-terrestrial network. Consequently, the communication system 1 becomes capable of extending a service to the terminal device 40 located in an area that cannot be covered by the terrestrial network. For example, the communication system 1 becomes capable of providing public safety communication and critical communication to a communication device such as an IoT (Internet of Things) device or an MTC (Machine Type Communications) device. Since the use of the non-terrestrial network improves service reliability and recoverability, the communication system 1 becomes capable of reducing vulnerability of a service against physical attacks or natural disasters. The communication system 1 can realize service connection to airplane passengers and aircraft terminal devices such as drones and service connection to mobile terminal devices such as ships and trains. Besides, the communication system 1 can realize provision of A/V content, group communication, an IoT broadcast service, a software download service, a high-efficiency multicast service such as an emergency message, a high-efficiency broadcast service, and the like. Further, the communication system 1 can also realize traffic offloading between a terrestrial network and a non-terrestrial network. In order to realize these, it is desirable that the non-terrestrial network provided by the communication system 1 is subjected to operation integration in an upper layer with the terrestrial network provided by the communication system 1. The non-terrestrial network provided by the communication system 1 desirably has a radio access scheme common to that of the terrestrial network provided by the communication system 1.

Note that the devices in the drawings may be considered devices in a logical sense. That is, a part of the devices in the drawings may be realized by a virtual machine (VM), a container (Container), a docker (Docker), and the like and may be implemented on physically the same hardware.

In the present embodiment, the ground station can be replaced as base station. The satellite station can be replaced as relay station. If the satellite station has a function of a base station, the satellite station can be replaced as base station.

Note that an LTE base station is sometimes referred to as eNodeB (Evolved Node B) or cNB. An NR base station is sometimes referred to as gNodeB or gNB. In LTE and NR, the terminal device 40 (also referred to as mobile station or terminal) is sometimes referred to as user equipment (UE). Note that the terminal device 40 is a type of a communication device and is also referred to as mobile station or terminal.

In the present embodiment, the concept of the communication device includes not only a portable mobile device (the terminal device 40) such as a mobile terminal but also a device installed in a structure or a mobile body. The structure or the mobile body itself may be regarded as the communication device. The concept of the communication device includes not only the terminal device 40 but also a base station and a relay device. The communication device is a type of a processing device and an information processing device. The communication device can be replaced as transmission device or reception device.

In the following explanation, configurations of the devices configuring the communication system 1 are specifically explained. Note that the configurations of the devices explained below are merely an example. The configurations of the devices may be different from the configurations explained below.

### <2.2. Configuration of the Management Device>

Subsequently, a configuration of the management device 10 is explained.

The management device 10 is a device that manages a wireless network. For example, the management device 10 is a device that manages communication of the ground station 20. If a core network is an EPC, the management device 10 is, for example, a device having a function of an MME (Mobility Management Entity). If the core network is 5 GC, the management device 10 is, for example, a device having a function of an AMF (Access and Mobility Management Function) and/or an SMF (Session Management Function). Naturally, the functions of the management device 10 are not limited to the MME, the AMF, and the SMF. For example, if the core network is 5 GC, the management device 10 may be a device having a function of an NSSF (Network Slice Selection Function), an AUSF (Authentication Server Function), or a UDM (Unified Data Management). The management device 10 may be a device having a function of an HSS (Home Subscriber Server).

Note that the management device 10 may have a function of a gateway. For example, if the core network is an EPC, the management device 10 may have a function of an SGW (Serving Gateway) or a P-GW (Packet Data Network Gateway). If the core network is 5 GC, the management device 10 may have a function of a UPF (User Plane Function). Note that the management device 10 may not always be a device configuring the core network. For example, it is assumed that the core network is a core network of W-CDMA (Wideband Code Division Multiple Access) or cdma2000 (Code Division Multiple Access 2000). At this time, the management device 10 may be a device that functions as an RNC (Radio Network Controller).

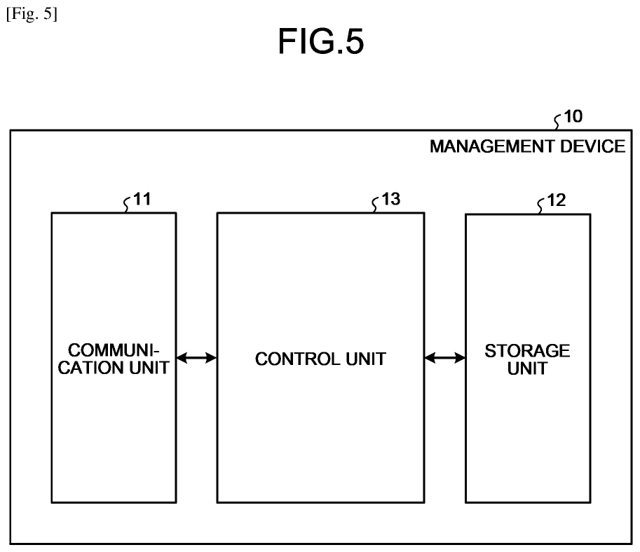

FIG. 5 is a diagram illustrating a configuration example of the management device 10 according to the embodiment of the present disclosure. The management device 10 includes a communication unit 11, a storage unit 12, and a control unit 13. Note that the configuration illustrated in FIG. 5 is a functional configuration. A hardware configuration may be different from this configuration. The functions of the management device 10 may be implemented in a distributed manner in a plurality of physically separated components. For example, the management device 10 may configured by a plurality of server devices.

The communication unit 11 is a communication interface for communicating with other devices. The communication unit 11 may be a network interface or may be a device connection interface. For example, the communication unit 11 may be a LAN (Local Area Network) interface such as an NIC (Network Interface Card) or may be a USB interface configured by a USB (Universal Serial Bus) host controller, a USB port, and the like. The communication unit 11 may be a wired interface or a wireless interface. The communication unit 11 functions as communication means of the management device 10. The communication unit 11 communicates with the ground station 20 and the like according to control of the control unit 13.

The storage unit 12 is a data readable/writable storage device such as a DRAM (Dynamic Random Access Memory), an SRAM (Static Random Access Memory), a flash memory, or a hard disk. The storage unit 12 functions as storage means of the management device 10. The storage unit 12 stores, for example, a connection state of the terminal device 40. For example, the storage unit 12 stores an RRC state and an ECM state of the terminal device 40. The storage unit 12 may function as a home memory that stores position information of the terminal device 40.

The control unit 13 is a controller that controls the units of the management device 10. The control unit 13 is realized by a processor such as a CPU (Central Processing Unit) or an MPU (Micro Processing Unit). For example, the control unit 13 is realized by the processor executing various programs stored in a storage device inside the management device 10 using a RAM (Random Access Memory) or the like as a work area. Note that the control unit 13 may be realized by an integrated circuit such as an ASIC (Application Specific Integrated Circuit) or an FPGA (Field Programmable Gate Array). All of the CPU, the MPU, the ASIC, and the FPGA can be regarded as a controller.

### <2.3. Configuration of the Ground Station>

Subsequently, a configuration of the ground station 20 is explained.

The ground station 20 is a wireless communication device that wirelessly communicates with the terminal device 40 via the satellite station 30. Note that the ground station 20 may be configured to communicate with the terminal device 40 not via the satellite station 30.

The ground station 20 is a type of a communication device. More specifically, the ground station 20 is a device equivalent to a radio base station (Base Station, Node B, eNB, gNB, or the like) or a wireless access point. The ground station 20 may be a wireless relay station. The ground station 20 may be an optical extension device called RRH (Remote Radio Head). The ground station 20 may be a receiving station such as an FPU (Field Pickup Unit). The ground station 20 may be an IAB (Integrated Access and Backhaul) donor node or an IAB relay node that provides a radio access line and a radio backhaul line by time division multiplexing, frequency division multiplexing, or space division multiplexing.

Note that a radio access technology used by the ground station 20 may be a cellular communication technology or a wireless LAN technology. Naturally, the radio access technology used by the ground station 20 is not limited the above and may be another radio access technology. For example, the radio access technology used by the ground station 20 may be an LPWA communication technology. Naturally, wireless communication used by the ground station 20 may be wireless communication using millimeter waves. The wireless communication used by the ground station 20 may be wireless communication using radio waves or wireless communication (optical wireless) using infrared rays or visible light.

The ground station 20 may be capable of performing NOMA (Non-Orthogonal Multiple Access) communication with the terminal device 40. Here, the NOMA communication is communication using a non-orthogonal resource (transmission, reception, or both of transmission and reception). Note that the ground station 20 may be capable of performing the NOMA communication with another ground station 20.

Note that the ground stations 20 may be capable of communicating with each other via a base station-core network interface (for example, S1 Interface). This interface may be either wired or wireless. The base stations may be capable of communicating with each other via an inter-base station interface (for example, X2 Interface or S1 Interface). This interface may be either wired or wireless.

Note that the concept of the base station includes not only a donor base station but also a relay base station (also referred to as relay station). The concept of the base station includes not only a structure having a function of the base station but also a device installed in the structure.

The structure is a building such as a high-rise building, a house, a steel tower, a station facility, an airport facility, a harbor facility, or a stadium. Note that the concept of the structure includes not only a building but also a structure (a non-building structure) such as a tunnel, a bridge, a dam, a wall, or an iron pillar and equipment such as a crane, a gate, or a windmill. The concept of the structure includes not only a structure on the land (the ground in a narrow sense) or in the ground but also a structure on water such as a platform or a mega-float, and a structure under water such as a marine observation facility. The base station may be replaced as information processing device.

The ground station 20 may be a donor station or a relay station. The ground station 20 may be a stationary station or a mobile station. The mobile station is a wireless communication device (for example, a base station) configured to be movable. At this time, the ground station 20 may be a device installed in a mobile body or may be the mobile body itself. For example, a relay station having mobility can be regarded as the ground station 20 functioning as a mobile station. In addition, a device originally having mobility such as a vehicle, a drone, or a smartphone and loaded with a function of a base station (at least a part of the function of the base station) also corresponds to the ground station 20 functioning as the mobile station.

Here, the mobile body may be a mobile terminal such as a smartphone or a mobile phone. The mobile body may be a mobile body (for example, a vehicle such as an automobile, a bicycle, a bus, a truck, a motorcycle, a train, or a linear motor car) that moves on the land (the ground in a narrow sense) or a mobile body (for example, a subway) that moves in the ground (for example, in a tunnel).

In addition, the mobile body may be a mobile body (for example, a ship such as a passenger ship, a cargo ship, or a hovercraft) that moves on water or a mobile body (for example, a submersible such as a submersible ship, submarine, or an unmanned submersible) that moves under water.

Note that the mobile body may be a mobile body (for example, an aircraft such as an airplane, an airship, or a drone) that moves in the atmosphere.

The ground station 20 may be a ground base station (a ground station) installed on the ground. For example, the ground station 20 may be a base station arranged in a structure on the ground or may be a base station installed in a mobile body moving on the ground. More specifically, the ground station 20 may be an antenna installed in a structure such as a building and a signal processing device connected to the antenna. Naturally, the ground station 20 may be the structure or the mobile body itself. The “ground” is a ground in a broad sense including not only on the land (on the ground in a narrow sense) but also on the ground, on water, and under water. Note that the ground station 20 is not limited to a ground base station. For example, the ground station 20 may be an aircraft station. From the viewpoint of the satellite station 30, an aircraft station located on the earth can also be regarded as a ground station.

The aircraft station is a wireless communication device capable of floating in the atmosphere such as an aircraft. The aircraft station may be a device loaded on an aircraft or the like or may be the aircraft itself. Note that the concept of the aircraft includes not only a heavy aircraft such as an airplane and a glider but also a light aircraft such as a balloon and an airship. The concept of the aircraft includes not only the heavy aircraft and the light aircraft but also a rotorcraft such as a helicopter and an auto-gyroscope. Note that the aircraft station (or an aircraft on which the aircraft station is loaded) may be an unmanned aircraft such as a drone.

Note that the concept of the unmanned aircraft also includes an unmanned aircraft system (UAS) and a tethered UAS. The concept of the unmanned aircraft includes a Lighter than Air UAS (LTA) and a Heavier than Air UAS (HTA). Besides, the concept of the unmanned aircraft also includes High Altitude UAS Platforms (HAPs).

The size of the coverage of the ground station 20 may be a large size such the size of as a macro cell or a small cell such as a picocell. Naturally, the size of the coverage of the ground station 20 may be an extremely small size such as the size of a femtocell. The ground station 20 may have a beamforming capability. In this case, a cell or a service area may be formed in the ground station 20 for each beam.

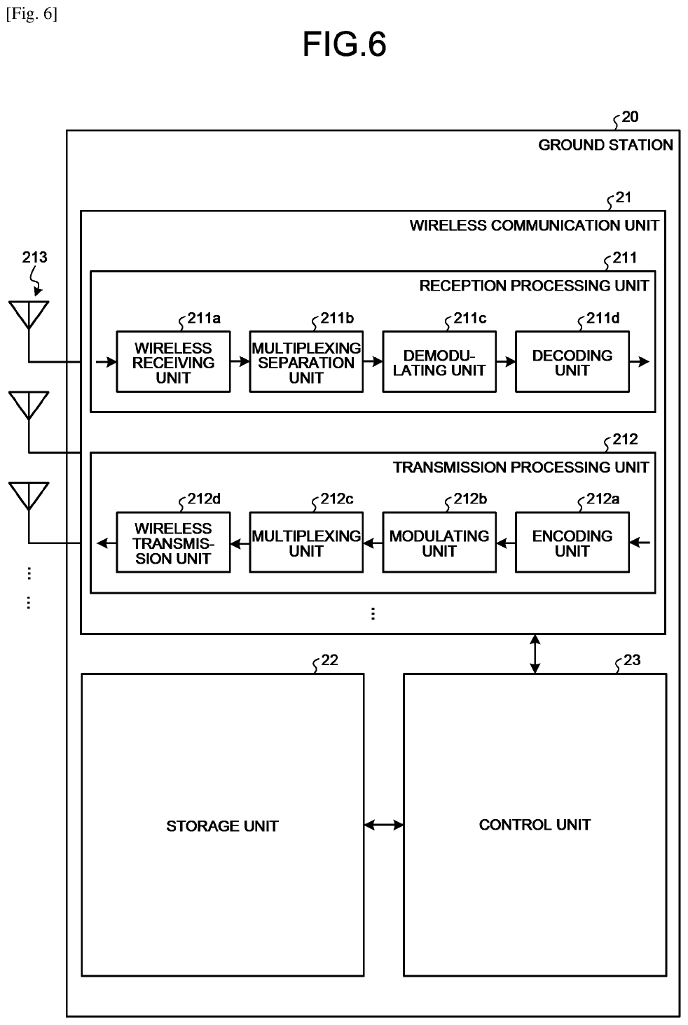

FIG. 6 is a diagram illustrating a configuration example of the ground station 20 according to the embodiment of the present disclosure. The ground station 20 includes a wireless communication unit 21, a storage unit 22, and a control unit 23. Note that the configuration illustrated in FIG. 6 is a functional configuration. A hardware configuration may be different from this configuration. The functions of the ground station 20 may be implemented in a distributed manner in a plurality of physically separated components.

The wireless communication unit 21 is a signal processing unit for wirelessly communicating with other wireless communication devices (for example, the terminal device 40). The wireless communication unit 21 operates under the control of the control unit 23. The wireless communication unit 21 is adapted to one or a plurality of radio access schemes. For example, the wireless communication unit 21 is adapted to both NR and LTE. The wireless communication unit 21 may be adapted to W-CDMA or cdma 2000 in addition to NR or LTE. The wireless communication unit 21 may be adapted to an automatic retransmission technology such as HARQ (Hybrid Automatic Repeat Request).

The wireless communication unit 21 includes a reception processing unit 211, a transmission processing unit 212, and an antenna 213. The wireless communication unit 21 may include a plurality of reception processing units 211, a plurality of transmission processing units 212, and a plurality of antennas 213. Note that, when the wireless communication unit 21 is adapted to a plurality of radio access schemes, the units of the wireless communication unit 21 can be configured individually for each of the radio access schemes. For example, the reception processing unit 211 and the transmission processing unit 212 may be individually configured by LTE and NR. The antenna 213 may be configured by a plurality of antenna elements (for example, a plurality of patch antennas). In this case, the wireless communication unit 21 may be configured to be capable of performing beamforming. The wireless communication unit 21 may be configured to be capable of performing polarization beamforming using vertically polarized waves (V-polarized waves) and horizontally polarized waves (H-polarized waves).

The reception processing unit 211 processes an uplink signal received via the antenna 213. For example, the reception processing unit 211 performs, on the uplink signal, down-conversion, removal of an unnecessary frequency component, control of an amplification level, quadrature demodulation, conversion to a digital signal, removal of a guard interval (cyclic prefix), extraction of a frequency domain signal by fast Fourier transform, and the like. Then, the reception processing unit 211 separates an uplink channel such as a PUSCH (Physical Uplink Shared Channel) and a PUCCH (Physical Uplink Control Channel) and an uplink reference signal from the signals subjected to these kinds of processing. The reception processing unit 211 demodulates the received signal using a modulation scheme such as BPSK (Binary Phase Shift Keying) or QPSK (Quadrature Phase Shift Keying) for a modulation symbol of the uplink channel. A modulation scheme used for demodulation may be 16QAM (Quadrature Amplitude Modulation), 64QAM, or 256QAM. In this case, signal points on a constellation do not always need to be equidistant. The constellation may be a non uniform constellation (NUC). The reception processing unit 211 performs decoding processing on a demodulated encoded bits of the uplink channel. Decoded uplink data and uplink control information are output to the control unit 23.

The transmission processing unit 212 performs transmission processing for downlink control information and downlink data. For example, the transmission processing unit 212 encodes the downlink control information and the downlink data input from the control unit 23 using an encoding scheme such as block encoding, convolutional encoding, turbo encoding, or the like. Then, the transmission processing unit 212 modulates encoded bits with a predetermined modulation scheme such as BPSK, QPSK, 16QAM, 64QAM, or 256QAM. In this case, signal points on a constellation do not always need to be equidistant. The constellation may be a non-uniform constellation. Then, the transmission processing unit 212 multiplexes modulation symbols and downlink reference signals of channels and arranges the multiplexed symbols the downlink reference signals in a predetermined resource element. Then, the transmission processing unit 212 performs various kinds of signal processing on the multiplexed signals. For example, the transmission processing unit 212 performs processing such as conversion into a time domain by fast Fourier transform, addition of a guard interval (a cyclic prefix), generation of a baseband digital signal, conversion into an analog signal, quadrature modulation, up-conversion, removal of an extra frequency component, and amplification of power. A signal generated by the transmission processing unit 212 is transmitted from the antenna 213.

The antenna 213 is an antenna device (an antenna unit) that mutually converts a current and a radio wave. The antenna 213 may be configured by one antenna element (for example, one patch antenna) or may be configured by a plurality of antenna elements (for example, a plurality of patch antennas). When the antenna 213 is configured by a plurality of antenna elements, the wireless communication unit 21 may be configured to be capable of performing beamforming. For example, the wireless communication unit 21 may be configured to generate a directional beam by controlling the directivity of a radio signal using the plurality of antenna elements. Note that the antenna 213 may be a dual-polarized antenna. When the antenna 213 is a dual-polarized antenna, the wireless communication unit 21 may use vertically polarized waves (V-polarized waves) and horizontally polarized waves (H-polarized waves) in transmitting radio signals. Then, the wireless communication unit 21 may control the directivity of the radio signal transmitted using the vertically polarized wave and the horizontally polarized wave.

The storage unit 22 is a data readable/writable storage device such as a DRAM, an SRAM, a flash memory, or a hard disk. The storage unit 22 functions as storage means of the ground station 20.

The control unit 23 is a controller that controls the units of the ground station 20. The control unit 23 is realized by a processor such as a CPU (Central Processing Unit) or an MPU (Micro Processing Unit). For example, the control unit 23 is implemented by the processor executing various programs stored in a storage device inside the ground station 20 using a RAM (Random Access Memory) or the like as a work area. Note that the control unit 23 may be realized by an integrated circuit such as an ASIC (Application Specific Integrated Circuit) or an FPGA (Field Programmable Gate Array). All of the CPU, the MPU, the ASIC, and the FPGA can be regarded as a controller.

Note that the base station 60 is a device that communicates with the terminal device 40 not via the satellite station 30 and can be configured in the same manner as the ground station 20.

### <2.4. Configuration of the Satellite Station>

Subsequently, a configuration of the satellite station 30 is explained.

The satellite station 30 is a relay station that relays communication between the ground station 20 and the terminal device 40. Note that the satellite station 30 may be a base station that provides the function of the base station to the terminal device 40.

The satellite station 30 is a wireless communication device capable of floating outside the atmosphere. The satellite station 30 may be a device loaded on a space mobile body such as an artificial satellite or may be the space mobile body itself. The space mobile body is a mobile body that moves outside the atmosphere. Examples of the space mobile body include artificial celestial bodies such as an artificial satellite, a spacecraft, a space station, and a probe.

Note that a satellite serving as the satellite station 30 may be any of a low earth orbiting (LEO) satellite, a medium earth orbiting (MEO) satellite, a geostationary earth orbiting (GEO) satellite, and a highly elliptical orbiting (HEO) satellite. Naturally, the satellite station may be a device loaded on the low earth orbiting satellite, the middle earth orbiting satellite, the geostationary earth orbiting satellite, or the high elliptical orbiting satellite.

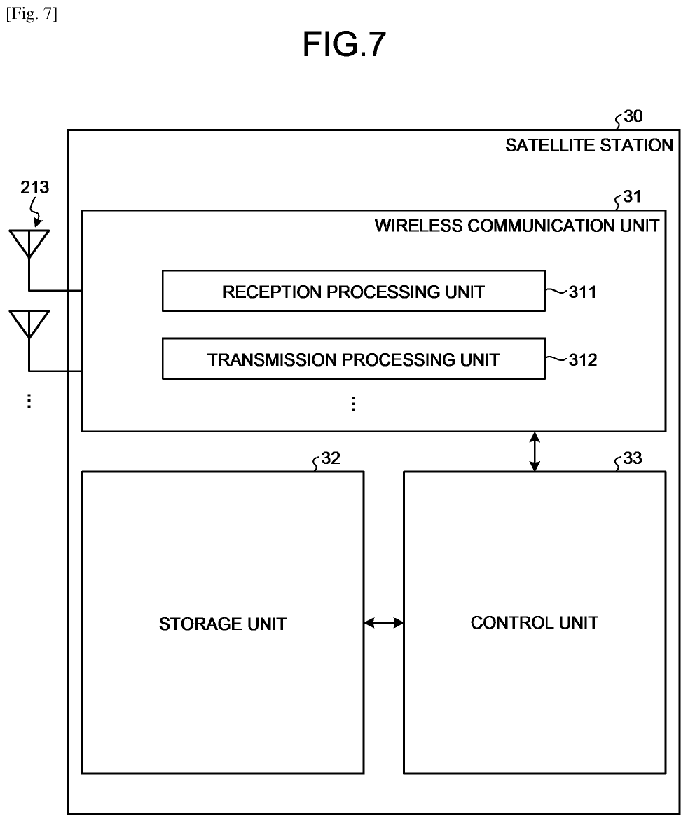

FIG. 7 is a diagram illustrating a configuration example of the satellite station 30 according to the embodiment of the present disclosure. The satellite station 30 includes a wireless communication unit 31, a storage unit 32, and a control unit 33. Note that the configuration illustrated in FIG. 7 is a functional configuration and a hardware configuration may be different from the functional configuration. The functions of the satellite station 30 may be implemented in a distributed manner in a plurality of physically separated components.

The wireless communication unit 31 is a wireless communication interface that wirelessly communicates with other wireless communication devices (for example, the ground station 20, the terminal device 40, the satellite station 50, and other satellite stations 30). The wireless communication unit 31 is adapted to one or a plurality of radio access schemes. For example, the wireless communication unit 31 is adapted to both of NR and LTE. The wireless communication unit 31 may be adapted to W-CDMA or cdma 3000 in addition to NR or LTE. The wireless communication unit 31 includes a reception processing unit 311, a transmission processing unit 312, and an antenna 313. The wireless communication unit 31 may include a plurality of reception processing units 311, a plurality of transmission processing units 312, and a plurality of antennas 313. Note that, when the wireless communication unit 31 is adapted to a plurality of radio access schemes, the units of the wireless communication unit 31 can be configured individually for each the radio access schemes. For example, the reception processing unit 311 and the transmission processing unit 312 may be individually configured by LTE and NR. The configurations of the reception processing unit 311, the transmission processing unit 312, and the antenna 313 are the same as the configurations of the reception processing unit 311, the transmission processing unit 312, and the antenna 313 explained above. Note that the wireless communication unit 31 may be configured to be capable of performing beamforming like the wireless communication unit 21.

The storage unit 32 is a storage device capable of reading and writing data such as a DRAM, an SRAM, a flash memory, or a hard disk. The storage unit 32 functions as storage means for the satellite station 30.

The control unit 33 is a controller that controls the units of the satellite station 30. The control unit 33 is realized by a processor such as a CPU or an MPU. For example, the control unit 33 is realized by the processor executing various programs stored in a storage device inside the satellite station 30 using a RAM or the like as a work area. Note that the control unit 33 may be realized by an integrated circuit such as an ASIC or an FPGA. All of the CPU, the MPU, the ASIC, and the FPGA can be regarded as a controller.

### <2.5. Configuration of the Terminal Device>

Subsequently, a configuration of the terminal device 40 is explained.

The terminal device 40 is a wireless communication device that wirelessly communicates with other communication devices such as the ground station 20, the satellite stations 30 and 50, the base station 60, and the aircraft station 70. The terminal device 40 is, for example, a mobile phone, a smart device (a smartphone or a tablet), a PDA (Personal Digital Assistant), or a personal computer. The terminal device 40 may be a device such as a camera for business use including a communication function or may be a motorcycle, a moving relay vehicle, or the like on which a communication device such as an FPU (Field Pickup Unit) is loaded. The terminal device 40 may be an M2M (Machine to Machine) device or an IoT (Internet of Things) device.

Note that the terminal device 40 may be able to perform NOMA communication with the ground station 20. The terminal device 40 may be capable of using an automatic retransmission technology such as HARQ when communicating with the ground station 20. The terminal device 40 may be capable of performing side-link communication with another terminal device 40. The terminal device 40 may also be capable of using the automatic retransmission technology such as HARQ when performing side-link communication. Note that the terminal device 40 may also be capable of performing NOMA communication in communication (side-link) with other terminal devices 40. Furthermore, the terminal device 40 may be capable of performing LPWA communication with other communication devices (for example, the ground station 20 and the other terminal devices 40). The wireless communication used by the terminal device 40 may be wireless communication using millimeter waves. Note that the wireless communication (side-link communication) used by the terminal device 40 may be wireless communication using radio waves or wireless communication (optical wireless) using infrared rays or visible light.

Furthermore, the terminal device 40 may be a mobile device. The mobile device is a movable wireless communication device. At this time, the terminal device 40 may be a wireless communication device installed in a mobile body or may be the mobile body itself. For example, the terminal device 40 may be a vehicle that moves on a road such as an automobile, a bus, a truck, or a motorcycle or a wireless communication device loaded on the vehicle. Note that the mobile body may be a mobile terminal or may be a mobile body that moves on the land (the ground in a narrow sense), in the ground, on water, or under water. The mobile body may be a mobile body that moves inside the atmosphere such as a drone or a helicopter or may be a mobile body that moves outside the atmosphere such as an artificial satellite.

The terminal device 40 may be simultaneously connected to a plurality of base stations or a plurality of cells to implement communication. For example, when one base station supports a communication area via a plurality of cells (for example, pCells or sCells), the plurality of cells can be bundled to perform communication between the ground station 20 and the terminal device 40 by a carrier aggregation (CA) technology, a dual connectivity (DC) technology, or a multi-connectivity (MC) technology. Alternatively, via cells of different ground stations 20, with a coordinated multi-point transmission and reception (COMP) technology, the terminal device 40 and those plurality of ground stations 20 can communicate.

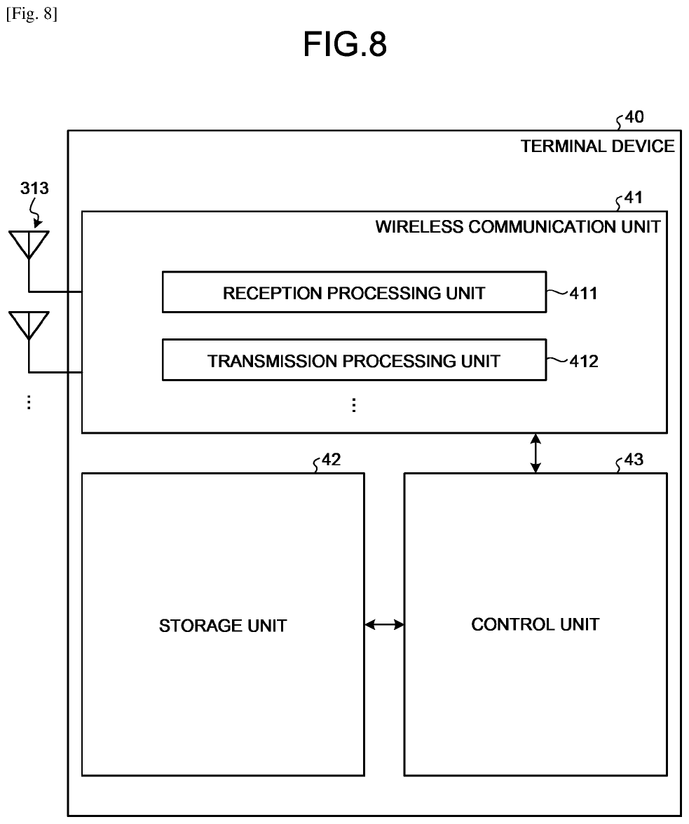

FIG. 8 is a diagram illustrating a configuration example of the terminal device 40 according to the embodiment of the present disclosure. The terminal device 40 includes a wireless communication unit 41, a storage unit 42, and a control unit 43. Note that the configuration illustrated in FIG. 8 is a functional configuration. A hardware configuration may be different from this configuration. The functions of the terminal device 40 may be implemented in a distributed manner in a plurality of physically separated components.

The wireless communication unit 41 is a signal processing unit for wirelessly communicating with other wireless communication devices (for example, the ground station 20 and the other terminal devices 40). The wireless communication unit 41 operates under the control of the control unit 43. The wireless communication unit 41 includes a reception processing unit 411, a transmission processing unit 412, and an antenna 413. The configurations of the wireless communication unit 41, the reception processing unit 411, the transmission processing unit 412, and the antenna 413 may be the same as those of the wireless communication unit 21, the reception processing unit 211, the transmission processing unit 212, and the antenna 213 of the ground station 20. The wireless communication unit 41 may be configured to be capable of performing beamforming like the wireless communication unit 21.

The storage unit 42 is a data readable/writable storage device such as a DRAM, an SRAM, a flash memory, or a hard disk. The storage unit 42 functions as storage means of the terminal device 40.

The control unit 43 is a controller that controls the units of the terminal device 40. The control unit 43 is realized by a processor such as a CPU or an MPU. For example, the control unit 43 is realized by the processor executing various programs stored in a storage device inside the terminal device 40 using a RAM or the like as a work area. Note that the control unit 43 may be realized by an integrated circuit such as an ASIC or an FPGA. All of the CPU, the MPU, the ASIC, and the FPGA can be regarded as a controller.

### 3. HANDOVER IN SATELLITE COMMUNICATION

Subsequently, handover between the satellite stations 30 is explained. Applying a handover technology to satellite communication is effective from the viewpoint of implementing smooth inter-cell movement of the terminal device 40.

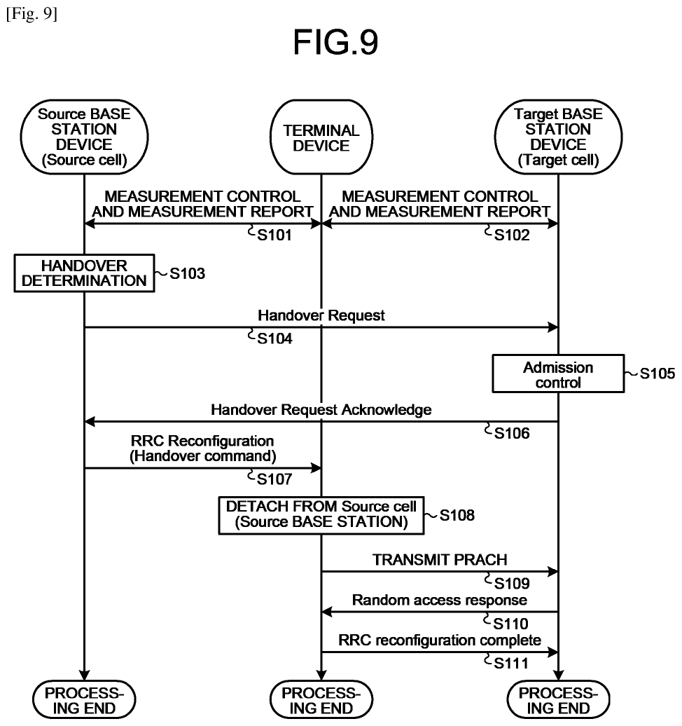

Here, an example of the handover is explained with reference to FIG. 9. FIG. 9 is a sequence chart for explaining an example of a handover flow. FIG. 9 illustrates a case in which the terminal device 40 performs handover from a Source cell of a Source base station device that is a handover source to a Target cell of a Target base station device that is a handover destination.

As illustrated in FIG. 9, the terminal device 40 implements measurement and transmits a measurement report to the Source base station device (step S101). Similarly, the terminal device 40 implements measurement and transmits a measurement report to the Target base station device (step S102).

The Source base station device determines based on the measurement report whether handover of the terminal device 40 is necessary (step S103). When determining that the handover is necessary, the Source base station device requests handover to the Target base station device (step S104).

When receiving the handover request, the Target base station device performs admission control (step S105) and notifies the source base station device of Acknowledge for the handover request (step S106).

Subsequently, the Source base station device transmits RRC Reconfiguration including a handover command to the terminal device 40 (step S107) and notifies the terminal device 40 of the implementation of the handover.

When receiving the RRC Reconfiguration, the terminal device 40 detaches from the Source cell of the Source base station device (step S108) and implements the initial access procedure with the Target base station device. For example, the terminal device 40 transmits a PRACH (Physical Random Access Channel) to the Target base station device (step S109). The target base station device transmits a Random Access response to the terminal device 40 (step S110). When the terminal device 40 transmits RRC reconfiguration complete to the Target base station device (step S111), the initial access procedure is completed and the handover processing is completed.

Note that, here, a case in which the terminal device 40 performs a 2-step random access procedure (2-step RACH) is explained as the initial access procedure but the present disclosure is not limited to this. The terminal device 40 may perform a 4-step random access procedure (4-step RACH) as the initial access procedure.

As explained above, in the handover illustrated in FIG. 9, the terminal device 40 starts the handover at timing when the terminal device 40 receives a handover command from the Source base station device.

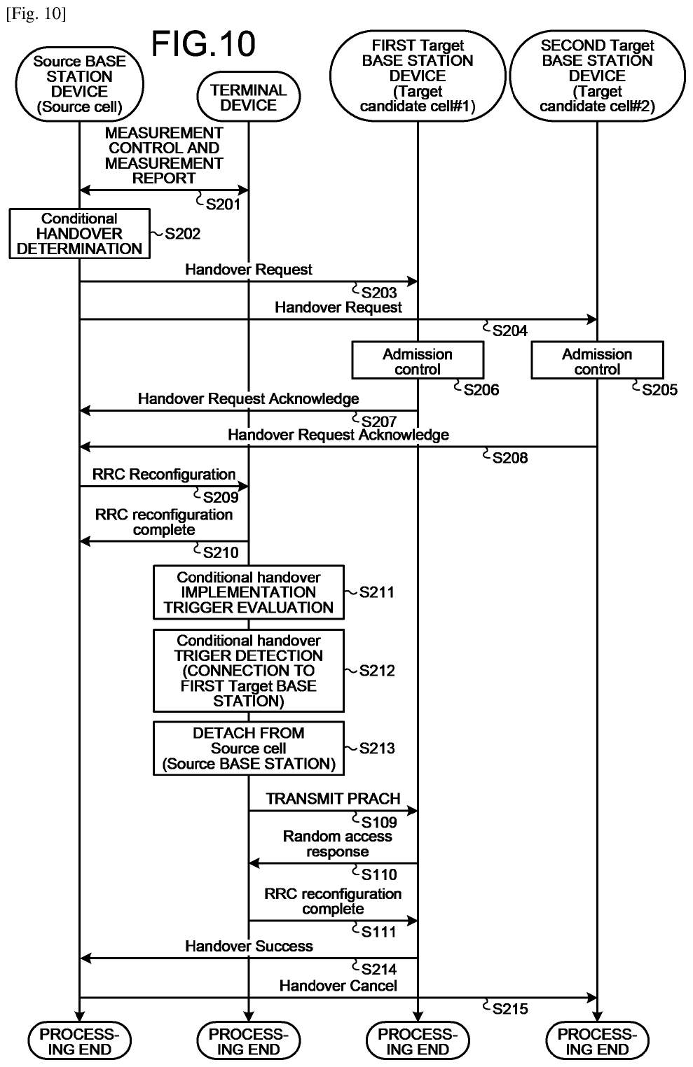

As another example of the handover, there is Conditional handover in which the Source base station device notifies the terminal device 40 of handover candidate destination information in advance. FIG. 10 is a sequence chart for explaining another example of the handover flow. FIG. 10 illustrates a case in which the terminal device 40 selects one of first and second Target base station devices that are handover destination candidates and executes handover. Note that the first Target base station device includes a target candidate cell #1 and the second Target base station device includes a target candidate cell #2.

As illustrated in FIG. 10, the terminal device 40 implements measurement and transmits a measurement report to the Source base station device (step S201).

The Source base station device determines based on the measurement report whether the Conditional handover of the terminal device 40 is necessary (step S202). When determining that the Conditional handover is necessary, the Source base station device requests the first Target base station device to perform handover (step S203) and requests the second Target base station device to perform handover (step S204).

When receiving the handover request, the first Target base station device performs admission control (step S205). Similarly, when receiving the handover request, the second Target base station device performs admission control (step S206). The first Target base station device notifies Acknowledge for the handover request to the Source base station device (step S207). The second Target base station device notifies Acknowledge for the handover request to the Source base station device (step S208).

Subsequently, the Source base station device transmits RRC Reconfiguration to the terminal device 40 (step S209). The RRC Reconfiguration includes, for example, information concerning the first and second target base station devices that are candidates of a handover destination and information concerning an implementation trigger for implementing the Conditional handover.

When receiving the RRC Reconfiguration, the terminal device 40 transmits RRC Reconfiguration complete to the Source base station device (step S210) and evaluates an implementation trigger for implementing the conditional handover (step S211). The terminal device 40 evaluates the implementation trigger and, when detecting the implementation trigger (step S212), detaches from the Source cell (the Source base station device) (step S213) and starts an initial connection procedure with a handover destination base station. Note that, in FIG. 10, it is assumed that the first Target base station device is detected as the handover destination base station.

As illustrated in FIG. 10, the terminal device 40 executes the initial connection procedure between the terminal device 40 and the first Target base station device. Note that the initial connection procedure is the same as the procedure illustrated in FIG. 9.

The first Target base station device that has completed the initial connection procedure and has been connected to the terminal device 40 notifies, to the Source base station device, Handover Success indicating that handover has succeeded (step S214). The Source base station device that has received the Handover Success notifies Handover Cancel to the second Target base station device not selected as the handover destination (step S215) to cancel the handover to the second Target base station device.

As explained above, in the Conditional handover, the Source base station device does not determine the Target base station device at the handover destination but notifies the Target base station device to be a candidate to the terminal device 40. Consequently, the terminal device 40 can select the Target base station device connectable at a point in time when the handover is performed and implement the handover.

In the Conditional handover, in order to realize seamless handover, the terminal device 40 detects, for example, an implementation trigger of the Conditional handover in step S212 in FIG. 10 and then detaches from the Source base station device in the next step S213. In other words, in order not to cause a period in which communication with all of the Source base station device and the Target base station device candidates becomes impossible and a period in which implementation of the initial connection becomes impossible, for example, the terminal device 40 detects the implementation trigger of the Conditional handover in step S212 of FIG. 10 and then detaches from the Source base station device in the next step S213.

Note that the satellite station 30 in the following explanation can be replaced with a non-ground base station device that operates as a communication device such as a drone, a balloon, or an airplane. Further, in communication called transparent payload, vent pipe, or the like, the base station device may represent a ground base station to which communication is performed via a satellite device. Without being limited the above, the present technique can also be applied to communication between the ground base station device and the terminal device 40.

In the following explanation, the satellite station 30 is sometimes simply described as base station device (Source base station device, Target base station device, and the like).

### 4. TECHNICAL CHARACTERISTICS

The handover of the satellite station 30 is explained above. Subsequently, an operation of the communication system 1 is explained. As explained above, an object of the communication system 1 of the present disclosure is to continue communication when non-line of sight communication occurs between the satellite station 30 and the terminal device 40.

Here, as a case in which the non-line of sight communication occurs between the satellite station 30 and the terminal device 40, several cases are conceivable, for example, a case in which the non-line of sight communication occurs because of an obstacle such as a cloud or a tunnel and a case in which the coverages of the plurality of satellite stations 30 do not overlap. Therefore, in the following explanation, the operation of the communication system 1 is explained below for each of the cases.

Note that, in the following explanation, it is assumed that V2X communication is performed in the communication system 1 but the application range of the technique of the present disclosure is not limited to the V2X communication. For example, the technique of the present disclosure can also be applied to a case in which high-speed large-capacity communication, voice communication, or IoT communication is performed in the communication system 1.

In the following explanation, when the base station device represents a base station device on the ground, the base station device is clearly written and described as the ground base station device 60. When the base station device is simply described as a base station device, the base station device is represented as a non-ground base station device including the satellite station 30 and the like.

As explained above, the base station device may include a base station device that implements communication referred to as a transparent payload, a vent pipe, or the like to which communication is performed via a satellite device.

Note that, in the following explanation, in order to simplify the explanation, it is assumed that the base station device (the non-ground base station device) is the satellite station 30. The satellite station 30 is described as base station device 30 as well. In addition, it is assumed that the coverage of the base station device is formed by the cell formed by the satellite station 30.

### 4.1. First Case

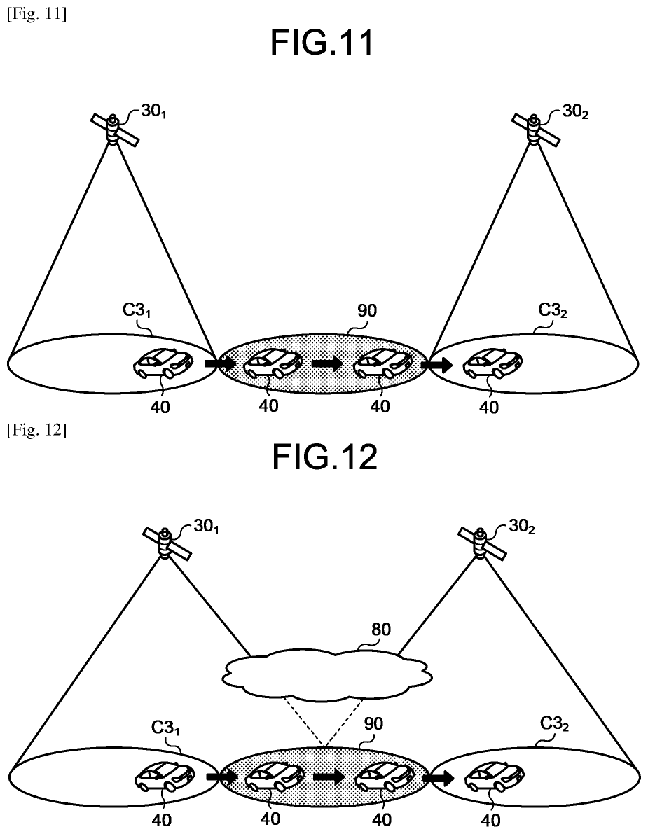

First, as a first case, a case in which the coverages of a plurality of base station devices 30 do not overlap is explained. FIG. 11 is a diagram for explaining an example of a first case of the communication system 1 according to the embodiment of the present disclosure.

In the example illustrated in FIG. 11, a plurality of base station devices 30₁ and 30₂ respectively form coverages C3₁ and C3₂. The base station devices 30₁ and 30₂ perform communication (satellite communication or non-terrestrial network communication) with the terminal devices 40 in the coverages C3₁ and C3₂.

As illustrated in FIG. 11, the coverages C3₁ and C3₂ do not overlap and there is a region 90 to be outside the coverage C3 of the base station device 30. In the region 90, satellite communication with the base station device 30 cannot be performed.

Here, when the terminal device 40 is a mobile body (for example, a vehicle), the terminal device 40 sometimes moves from the inside of the coverage C3₁ to the region 90 outside the coverage C3₁ of the base station device 30₁ according to movement. The terminal device 40 sometimes moves from the region 90 outside the coverage C3₁ of the base station device 30₁ to the inside of the coverage C3₂ of the base station device 30₂ according to the movement.

As explained above, when the terminal device 40 moves from the inside of the coverage C3 to the outside of the coverage C3 of the base station device 30, communication of the terminal device 40 is requested to be continued. Furthermore, when the terminal device 40 moves from the outside of the coverage C3 of the base station device 30 to the inside of the coverage C3, communication of the terminal device 40 is required to be continued.

Note that a case in which the region 90 to be outside the coverage C3 is present between the coverages C3₁ and C3₂ of the plurality of base station devices 30₁ and 30₂ is not limited to the example illustrated in FIG. 11.

FIG. 12 is a diagram for explaining another example of the first case of the communication system 1 according to the embodiment of the present disclosure.

In the example illustrated in FIG. 12, the coverages C3₁ and C3₂ of the base station devices 30₁ and 30₂ are adjacent (or overlap). However, the region 90 to be outside the coverages C3₁ and C3₂ of the base station devices 30₁ and 30₂ because of an obstacle 80 (cloud in the example illustrated in FIG. 12). In the region 90, the terminal device 40 cannot perform satellite communication with the base station device 30. Note that the obstacle 80 is not limited to a natural object such as a cloud. For example, a structure such as a tunnel can also be the obstacle 80.

As explained above, even if the coverages C3₁ and C3₂ of the base station devices 30₁ and 30₂ are adjacent (or overlap), there is a case in which the region 90 where the terminal device 40 cannot communicate with the base station device 30 because of the influence of the obstacle 80 is present.

The number of base station devices 30 is not limited to two. For example, even when the number of base station devices 30 is three or more, there is a case in which the region 90 where the terminal device 40 cannot communicate with the base station device 30 is present.

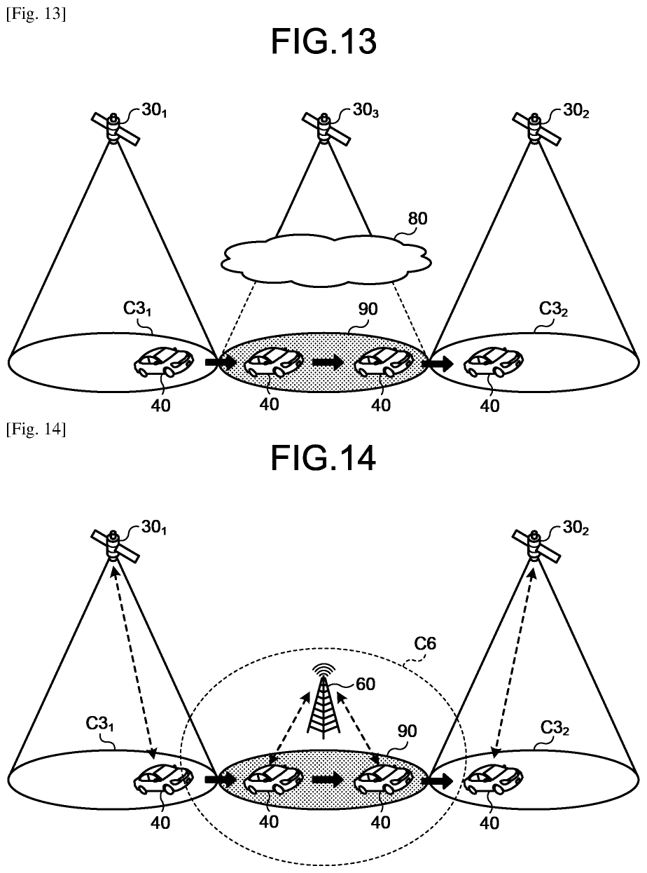

FIG. 13 is a diagram for explaining another example of the first case of the communication system 1 according to the embodiment of the present disclosure.

FIG. 13 illustrates a case in which there are three base station devices 30. The base station devices 30₁ and 30₂ perform communication (satellite communication) with the terminal devices 40 in the coverages C3₁ and C3₂. However, the base station device 30₃ cannot perform communication (satellite communication) with the terminal device 40 because of the obstacle 80 (the cloud in the example illustrated in FIG. 13). As explained above, there is a case in which the region 90 that is outside the coverage C3 of the base station device 30₃ is caused by the obstacle 80.

As explained above, when the terminal device 40 moves from the inside of the coverage C3 to the outside of the coverage C3 of the base station device 30, the communication of the terminal device 40 is requested to be continued. Furthermore, when the terminal device 40 moves from the outside of the coverage C3 of the base station device 30 to the inside of the coverage C3, communication of the terminal device 40 is required to be continued.

Therefore, in the embodiment of the present disclosure, when the terminal device 40 moves from the inside of the coverage C3 to the outside of the coverage C3 of the base station device 30, the terminal device 40 continues communication by performing non-satellite communication. When the terminal device 40 moves from the outside of the coverage C3 of the base station device 30 to the inside of the coverage C3, the terminal device 40 continues communication by performing satellite communication.

Note that the non-satellite communication includes ground communication performed between the ground base station device 60 and the terminal device 40 and side-link communication performed between the terminal devices 40.

<4.1.1. Case in which Communication is Continued by Ground Communication>

FIG. 14 is a diagram for explaining an example of communication by the communication system 1 according to the embodiment of the present disclosure. In FIG. 14, the terminal device 40 performs ground communication with the ground base station device 30 on the outside of the coverage C3 of the base station device 60.

As illustrated in FIG. 14, when the terminal device 40 is located within the coverage C3₁ of the base station device 30₁, the terminal device 40 performs satellite communication with the base station device 30₁. At this time, the base station device 30₁ can collect terminal information from the terminal device 40. The base station device 30₁ uses the terminal information to determine, for example, when the terminal device 40 moves to the outside of the coverage C3₁ of the base station device 30₁.

After moving from the inside of the coverage C3₁ of the base station device 30₁ to the region 90 outside the coverage C3₁, the terminal device 40 communicates with the ground base station device 60. Communication between the terminal device 40 and the ground base station device 60 is non-satellite communication performed via a terrestrial network. As explained above, the terminal device 40 can ensure highly reliable communication by performing the handover from the base station device 30₁ to the ground base station device 60.

At this time, the terminal device 40 performs non-satellite communication with the ground base station device 60 using non-satellite communication information acquired from the base station device 30₁. For example, the terminal device 40 executes handover (also described as first handover) from the base station device 30₁ to the ground base station device 60 using the non-satellite communication information. Note that the handover illustrated in FIG. 9 or the conditional handover illustrated in FIG. 10 may be applied as the handover.

The terminal device 40 can perform the first handover, for example, on a timer basis. In this case, the base station device 30 sets a timer until the first handover is performed on the terminal device 40. The terminal device 40 starts a procedure of the first handover at timing when the timer expires.

Alternatively, the terminal device 40 can determine, based on position information of the terminal device 40 and orbit information of the satellite (the base station device 30₁), timing for performing the first handover. The terminal device 40 may decide, based on the position information of the terminal device 40 or the orbit information of the satellite, the timing for performing the first handover. Alternatively, the terminal device 40 may perform the first handover according to trigger information concerning the timing of the first handover provided from the base station device 30₁.

Consequently, the terminal device 40 can more smoothly execute the handover from the base station device 30₁ to the ground base station device 60 and can ensure more reliable communication.

After moving from the outside of the coverage C3₁ of the base station device 30₁ to the inside of the coverage C3₂ of the base station device 30₂, the terminal device 40 performs satellite communication with the base station device 30₂ different from the base station device 30₁. As explained above, the terminal device 40 can ensure highly reliable communication by performing the handover from the ground base station device 60 to the base station device 30₂.

At this time, the terminal device 40 performs satellite communication with the base station device 30₂ using the satellite communication information acquired from the base station device 30₁ or/and the ground base station device 60. For example, the terminal device 40 executes handover (hereinafter also referred to as second handover) from the ground base station device 60 to the base station device 30₂ using the satellite communication information. Note that the handover illustrated in FIG. 9 or the conditional handover illustrated in FIG. 10 may be applied as the handover.

The terminal device 40 can execute the second handover, for example, on a timer basis. In this case, the base station device 30₁ or/and the ground base station device 60 sets, for the terminal device 40, a timer until the second handover is performed. The terminal device 40 starts a procedure of the second handover at timing when the timer expires.

Alternatively, the terminal device 40 can determine, based on the position information of the terminal device 40 and the orbit information of the satellite (the base station device 30₂), the timing for performing the second handover. The terminal device 40 may decide, based on the position information of the terminal device 40 and the orbit information of the satellite, the timing for performing the second handover. Alternatively, the terminal device 40 may perform the first handover according to trigger information concerning the timing of the second handover provided from the base station device 30₁ or/and the ground base station device 60.

Consequently, the terminal device 40 can more smoothly execute the handover from the ground base station device 60 to the base station device 30₂ and can ensure more reliable communication.

Note that, in the first case illustrated in FIG. 14, the base station device (the satellite station) 30 to be connected is different before the terminal device 40 enters a non-ground communication coverage and after the terminal device exits the non-ground communication coverage. As illustrated in FIG. 14, the terminal device 40 is connected to base station device 30₁ in the coverage C3₁ and is connected to base station device 30₂ in coverage C3₂.

As explained above, the base station device (the satellite station) 30 to be connected is sometimes different before the terminal device 40 enters the non-ground communication coverage and after the terminal device exits the non-ground communication coverage. In such a case, for example, information including at least one of signaling information (for example, non-satellite communication information) explained below can be shared among the base station devices 30.

That is, the base station device 30₁ can notify the base station device 30₂ of the information including at least one of the signaling information explained below. For example, the base station device 30₁ notifies the base station device 30₂ of information concerning a handover procedure to a Target cell explained below, information concerning a handover trigger to the Target cell, and the like.

Consequently, the terminal device 40 can implement smoother handover.

Since information (an example of inter-satellite information) is shared between the base station devices 30₁ and 30₂, the terminal device 40 can implement transparent handover. Here, the transparent handover is means for resuming communication with the base station device 30 without being aware of whether the base station device 30 to be connected is the same or different before the terminal device 40 enters the non-ground communication coverage and after the terminal device exits the non-ground communication coverage. By implementing the transparent handover, the terminal device 40 can resume satellite communication without being aware of whether the base station devices 30 to be connected are the same or different from the viewpoint of the terminal device 40.

In this case, the base station device 30 does not have to notify the terminal device 40 of information concerning handover (for example, first handover (HO) information and/or second HO information). For example, the base station device 30 and the terminal device 40 can implement communication including handover as in a second case explained below.

### Signaling Example

An example of signaling information used in communication in the first case is explained below.

### (Terminal Information)

For example, the terminal device 40 can notify the base station device 30 of information concerning movement to the outside of the non-ground communication coverage as terminal information. The terminal information can be notified, for example, before the terminal device 40 moves from the inside of the coverage C3 to the outside of the coverage C3 of the base station device 30, that is, from the inside of the non-ground communication coverage area to the outside of the non-ground communication coverage area.

The terminal information can include at least one piece of the following information.
Information concerning a location such as position information of the terminal device 40
Information concerning mobility such as speed information and a moving direction of the terminal device 40
Sensing information of the terminal device 40
Information concerning a terminal state of the terminal device 40

The sensing information of the terminal device 40 can include, for example, information concerning obstacles such as tunnels and clouds, position information and mobility information of other terminal devices 40 around the terminal device 40, information such as weather, and information concerning brightness around the terminal device 40.

The information concerning the terminal state of the terminal device 40 can include, for example, capability of the terminal device 40, fuel or battery residual power information of the terminal device 40, accident history information of the terminal device 40, temperature information of the terminal device 40, and inspection implementation history information of the terminal device 40.

The terminal device 40 can notify the base station device 30 of the terminal information at any time, for example, if the terminal device 40 can communicate with the base station device 30, for example, the terminal device 40 is located within the coverage C3 of the base station device 30.

For example, the terminal device 40 may notify the terminal information at timing when a request (an implementation request for information notification) from the base station device 30 is notified. That is, the terminal device 40 notifies the base station device 30 of terminal information in response to a request from the base station device 30. Alternatively, the terminal device 40 may notify the base station device 30 of the terminal information at preset periodic timing (Semi-persistent timing).

### (Non-Satellite Communication Information)

The non-satellite communication information is signaling information used for movement from the inside of the coverage C3 to the outside of the coverage C3 of the base station device 30, that is, from the inside of the non-ground communication coverage area to the outside of the non-ground communication coverage area. The non-satellite communication information is notified from the base station device 30 to the terminal device 40.

The non-satellite communication information may include, for example, first HO information concerning implementation of the first handover, first trigger information concerning a movement trigger to the outside of the non-ground communication coverage, and the like.

### (First HO Information)

The first HO information includes, for example, information concerning implementation of the first handover to the ground base station device 60. Note that the first HO information may include information concerning handover (the second handover explained above) from the ground base station device 60 to the base station device 30.

The first HO information can include at least one piece of the following information.
Information concerning a handover procedure to a Target cell
Information concerning a handover execution trigger to the Target cell
Information concerning detachment implementation from a Source cell
Information concerning next and subsequent handover destinations

The information concerning handover procedure to a Target cell is, for example, information concerning a first handover procedure to a Target cell (the ground base station device 60). The information can include, for example, at least one piece of the following information.
PRACH (Physical Random Access Channel) transmission resource of the Target cell
PRACH transmission Preamble sequence of the Target cell
Cell ID of the Target cell
Uplink/Downlink carrier frequency of the Target cell
Bandwidth of the Target cell
Terminal specific ID (C-RNTI (Cell-Radio Network Temporary ID)) after handover
Radio Resource Configuration after the handover
Condition for updating an information set concerning the handover
Trigger information for implementing the handover
Timing advance information of the Target cell
SSB index of the Target cell
Information concerning transmission weight
Information concerning 2-STEP initial access

The information concerning a handover implementation trigger to a target cell (the ground base station device 60) can include, for example, the following information.
RSRP (Reference Signal Received Power) information of a Target cell candidate
RSRQ (Reference Signal Received Quality) information of the Target cell candidate
RSSI (Received Signal Strength Indication) information of the Target cell candidate
Timer information concerning handover implementation for the Target cell candidate
Information concerning start time of the handover implementation for the Target cell candidate
Information concerning implementation start time of a handover execution trigger detection operation of the Target cell candidate
Information concerning an operation after a timer concerning handover implementation for the Target cell candidate expires
Operation in the case in which a synchronization signal of a cell other than the Target cell candidate is received

The information concerning detachment implementation from a Source cell (the base station device 30) can include, for example, at least one piece of the following information.
RSRP information of the Source cell
RSRQ information of the Source cell
RSSI information of the Source cell
Information concerning a timer for implementing detachment from the Source cell
Information concerning time when detachment from the Source cell is implemented
Information concerning execution of the detachment implementation from the Source cell

Information concerning the next and subsequent handover destinations can be notified from the base station device 30₁ to the terminal device 40 in addition to information concerning the next handover destination (for example, the ground base station device 60). The information concerning the next and subsequent handover destinations can be the same as the first HO information except that a Target cell is the next and subsequent handover destinations (for example, the base station device 30₂) and a Source cell is the next handover destination (for example, the ground base station device 60). Information concerning the next and subsequent handover destinations may include information concerning consecutive handover execution timings.

### (First Trigger Information)

As explained above, the non-satellite communication information can include, for example, the first trigger information concerning a movement trigger to the outside of the non-ground communication coverage. The base station device 30 may notify the terminal device 40 of the first trigger information in advance. When receiving the first trigger information, the terminal device 40 implements movement to the outside of the non-ground communication coverage based on the first trigger information.

The first trigger information can include, for example, at least one piece of the following information.
Threshold information (for example, RSRP threshold information, RSRQ threshold information, and RSSI threshold information) concerning received power of the non-ground communication cell (within the non-ground communication coverage)
Information concerning a timer for implementing movement from the inside of the non-ground communication coverage to the outside of the non-ground communication coverage
Information concerning time when movement from the inside of the non-ground communication coverage to the outside of the non-ground communication coverage is implemented
Information concerning execution of movement from the inside of the non-ground communication coverage to the outside of the non-ground communication coverage

### (Satellite Communication Information)

The satellite communication information is signaling information used for movement from the outside of the coverage C3 to the inside of the coverage C3 of the base station device 30, that is, from the outside of the non-ground communication coverage area to the inside of the non-ground communication coverage area. The satellite communication information is notified from the base station device 30 or/and the ground base station device 60 to the terminal device 40.

The satellite communication information may include, for example, second HO information concerning implementation of the second handover and second trigger information concerning a movement trigger to the inside of the non-ground communication coverage.

### (Second HO Information)

The second HO information includes, for example, information concerning second handover implementation to the base station device 30₂. Note that the second HO information can include the same information as the first HO information except that the Target cell is, for example, the base station device 30₂ and the Source cell is, for example, the ground base station device 60.

### (Second Trigger Information)

The second trigger information can include, for example, information concerning a movement trigger to the inside of the non-ground communication coverage. The base station device 30 or/and the ground base station device 60 may notify the terminal device 40 of the second trigger information in advance. When receiving the second trigger information, the terminal device 40 implements movement to the inside of the non-ground communication coverage based on the second trigger information.

The second trigger information can include, for example, at least one piece of the following information.
RSRP threshold information of a ground communication cell
RSRQ threshold information of the ground communication cell
RSSI threshold information of a ground communication cell
Information concerning a timer for implementing movement from the outside of the non-ground communication coverage to the inside of the non-ground communication coverage
Information concerning time when movement from the outside of the non-ground communication coverage to the inside of the non-ground communication coverage is implemented
Information concerning execution of movement from the outside of the non-ground communication coverage to the inside of the non-ground communication coverage

### (Second Terminal Information)

For example, the terminal device 40 can notify the base station device 30 or/and the ground base station device 60 of information concerning movement to the inside of the non-ground communication coverage as the second terminal information. The second terminal information can be notified, for example, before the terminal device 40 moves from the outside of the coverage C3 to the inside of the coverage C3 of the base station device 30, that is, from the outside of the non-ground communication coverage area to the inside of the non-ground communication coverage area.

The second terminal information can include, for example, the same information as the terminal information explained above. For example, if the terminal device 40 is capable of communicating with the base station device 30 or/and the ground base station device 60, the terminal device 40 can always notify the base station device 30 or/and the ground base station device 60 of the second terminal information.

For example, the terminal device 40 may notify the second terminal information at timing when a request (an implementation request for information notification) from the base station device 30 or/and the ground base station device 60 is notified. That is, the terminal device 40 notifies the base station device 30 or/and the ground base station device 60 of terminal information in response to the request from the base station device 30 or/and the ground base station device 60. Alternatively, the terminal device 40 may notify the base station device 30 or/and the ground base station device 60 of the second terminal information at preset periodic timing (Semi-persistent timing).

### (Communication Processing Example)

A communication processing example in the case in which the communication system 1 continues communication by performing ground communication on the outside of the non-ground communication coverage is explained. Note that the communication processing example explained below is an example and processing other than the communication processing example explained below may be executed in the communication system 1 according to the embodiment of the present disclosure.

### (Notification Processing)

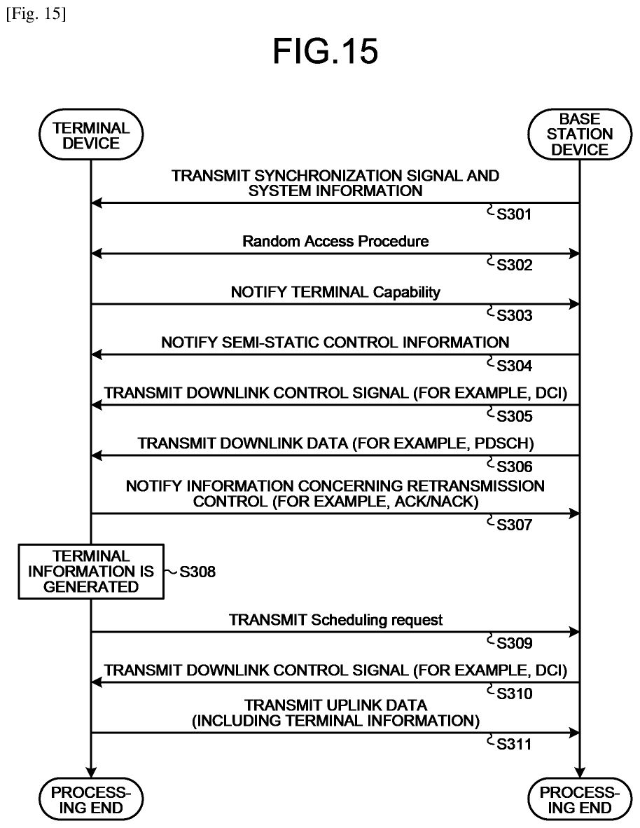

FIG. 15 is a sequence chart illustrating an example of a flow of notification processing for terminal information according to the embodiment of the present disclosure. The notification processing illustrated in FIG. 15 is performed between the terminal device 40 and the base station device 30 within the non-ground communication coverage.

The base station device 30 transmits a synchronization signal and system information to the terminal device 40 (step S301). The system information can include an explicit notification for implementing communication according to the embodiment of the present disclosure.

Subsequently, the base station device 30 implements a Random Access Procedure between the base station device 30 and the terminal device 40 (step S302). At this time, the terminal device 40 may notify the base station device 30 of information data such as information concerning the terminal device 40 and sensing information.

The terminal device 40 notifies the base station device 30 of terminal Capability (step S303). The terminal Capability can include Capability concerning communication (for example, the first handover and/or the second handover) according to the embodiment of the present disclosure. That is, the terminal Capability can include, for example, information indicating whether the first handover and/or the second handover can be implemented.

The base station device 30 notifies the terminal device 40 of semi-static control information (step S304). The control information can include information concerning the communication according to the embodiment of the present disclosure.

The base station device 30 notifies the terminal device 40 of downlink control information (step S305). The control information can include information concerning the communication according to the embodiment of the present disclosure such as DCI (Downlink Control Information).

The base station device 30 transmits downlink data to the terminal device 40 (step S306). The base station device 30 transmits the downlink data using, for example, a PDSCH (Physical Downlink Shared Channel) or the like.

When receiving the downlink data, the terminal device 40 notifies the base station device 30 of information concerning retransmission control (step S307). The information concerning the retransmission control can include, for example, ACK/NACK.

Here, it is assumed that terminal information (information data such as terminal information and sensing information) is generated in the terminal device 40 (step S308).

In this case, the terminal device 40 transmits a Scheduling request to the base station device 30 (step S309).

The base station device 30 notifies the terminal device 40 of downlink control information (step S310). The control information can include information concerning the communication according to the embodiment of the present disclosure such as DCI (Downlink Control Information).

The terminal device 40 transmits uplink data to the base station device 30 (step S311). The uplink data can include terminal information (information data such as terminal information and sensing information).

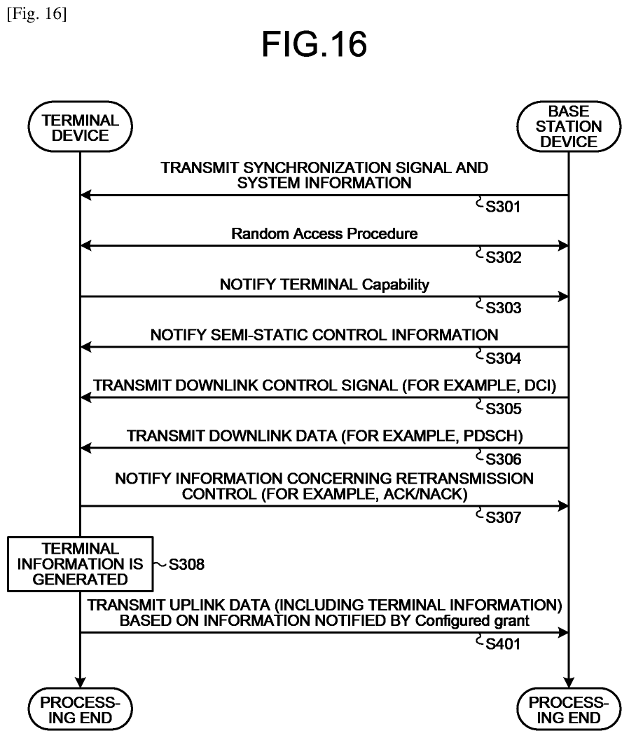

FIG. 16 is a sequence chart illustrating another example of the flow of the notification processing for the terminal information according to the embodiment of the present disclosure. The notification processing illustrated in FIG. 16 is performed between the terminal device 40 and the base station device 30 within the non-ground communication coverage. Note that processing until the terminal information is generated in step S308 is the same as that illustrated in FIG. 15.

When the terminal information is generated, the terminal device 40 transmits the uplink data to the base station device 30 based on information notified by Configured grant (step S401). The uplink data can include terminal information (information data such as terminal information and sensing information).

As explained above, when terminal information is generated during communication (satellite communication) with the base station device 30, the terminal device 40 notifies the base station device 30 of the terminal information.

Note that the terminal device 40 may notify the base station device 30 of the terminal information in response to an instruction from the base station device 30 or may periodically notify the base station device 30 of the terminal information.

### (Handover Processing)

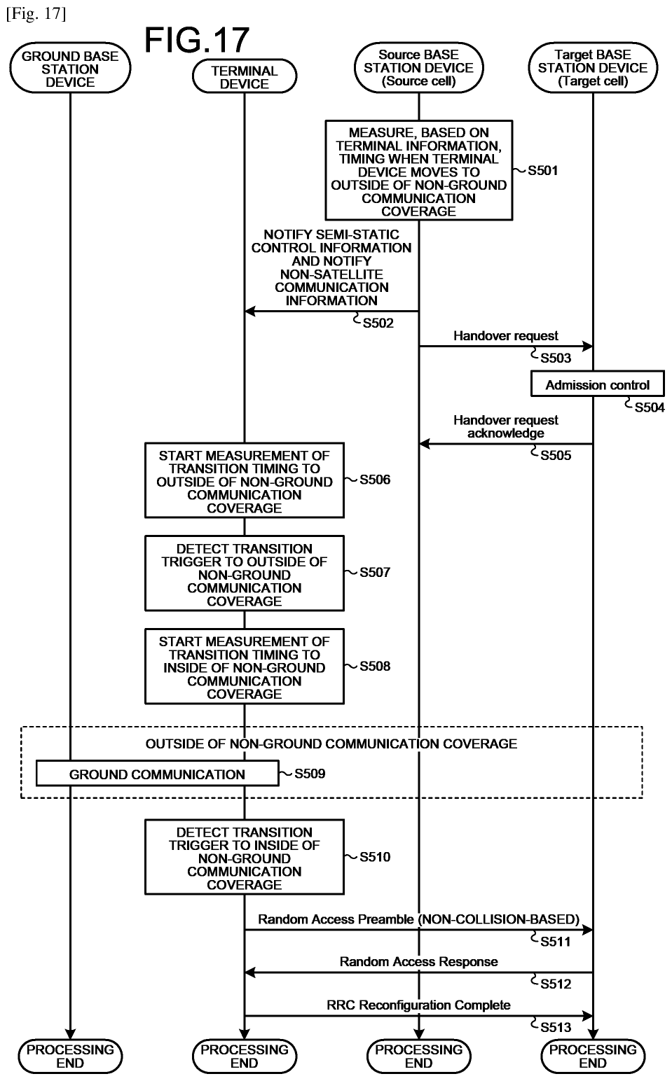

FIG. 17 is a sequence chart illustrating an example of a flow of handover processing according to the embodiment of the present disclosure. The handover processing illustrated in FIG. 17 includes the first handover (movement from the inside of the non-ground communication coverage to the outside of the coverage) and the second handover (movement from the outside of the non-ground communication coverage to the inside of the coverage) explained above.

The Source base station device illustrated in FIG. 17 is the base station device 30₁ (see FIG. 14) that performs satellite communication with the terminal device 40 before moving from the inside of the non-ground communication coverage to the outside of the coverage.

The ground base station device illustrated in FIG. 17 is the ground base station device 60 (see FIG. 14) that performs ground communication with the terminal device 40 after moving from the inside of the non-ground communication coverage to the outside of the coverage.

The Target base station device illustrated in FIG. 17 is the base station device 30₂ (see FIG. 14) that performs satellite communication with the terminal device 40 after moving from the outside of the non-ground communication coverage to the inside of the coverage.

It is assumed that, for example, the notification processing illustrated in FIG. 15 or FIG. 16 is executed between the Source base station device and the terminal device 40 before the handover processing illustrated in FIG. 17 is executed. That is, it is assumed that the Source base station device has acquired terminal information concerning the terminal device 40.

As illustrated in FIG. 17, the Source base station device measures, based on the terminal information, timing when the terminal device 40 moves to the outside of the non-ground communication coverage (step S501).

The Source base station device notifies the terminal device 40 of semi-static control information and also notifies the terminal device 40 of non-satellite communication information (step S502).

The Source base station device requests the Target base station device to perform handover (step S503).

When receiving the handover request, the target base station device performs admission control (step S504) and notifies the source base station device of Acknowledge for the handover request (step S505).

Furthermore, the terminal device 40 that has received the non-satellite communication information starts measuring transition timing to the outside of the non-ground communication coverage (step S506). For example, the terminal device 40 starts, based on the first trigger information included in the non-satellite communication information, measuring timing for implementing the first handover.

Here, it is assumed that, as a result of the measurement, the terminal device 40 detects a transition trigger to the outside of the non-ground communication coverage (step S507). In this case, the terminal device 40 starts communication (ground communication) outside the non-ground communication coverage. For example, the terminal device 40 implements the first handover.

After starting the ground communication, the terminal device 40 starts measuring transition timing to the inside of the non-ground communication coverage (step S508).

Thereafter, the terminal device 40 executes ground communication between the terminal device 40 and the ground base station device 60 (step S509).

Here, it is assumed that the terminal device 40 detects a transition trigger to the inside of the non-ground communication coverage (step S510). In this case, the terminal device 40 starts communication (satellite communication) within the non-ground communication coverage. For example, the terminal device 40 implements the second handover.

The terminal device 40 transmits a Random Access Preamble to the Target base station device (step S511). The terminal device 40 transmits, for example, a non-collision-based Random Access Preamble to the Target base station device.

The Target base station device transmits a Random Access Response to the terminal device 40 (step S512). The terminal device 40 transmits RRC Reconfiguration Complete to the Target base station device (step S513).

Thereafter, the terminal device 40 executes satellite communication with the Target base station device.

As explained above, when the terminal device 40 moves from the inside of the non-ground communication coverage to the outside of the coverage, the terminal device 40 performs ground communication with the ground base station device 60. When the terminal device 40 moves from the outside of the non-ground communication coverage to the inside of the coverage, the terminal device performs non-ground communication with the Target base station device.

At this time, the terminal device 40 performs, for example, ground communication including the first handover with the ground base station device 60 using non-satellite communication information acquired from the Source base station device. The terminal device 40 performs, for example, non-ground communication including the second handover with the Target base station device using satellite communication information acquired from the Source base station device and/or the ground base station device 60.

As a result, the terminal device 40 can ensure highly reliable communication even when moving from the inside of the non-ground communication coverage to the outside of the coverage or from the outside of the non-ground communication coverage to the inside of the coverage.

### <4.1.2. When Communication is Continued by Side-Link Communication>

In the example explained above, the terminal device 40 performs the ground communication with the ground base station device 60 as non-satellite communication outside the non-ground communication coverage. However, the non-satellite communication performed by the terminal device 40 is not limited to the ground communication. For example, the terminal device 40 may perform side-link communication with another terminal device 40 as the non-satellite communication.

For example, it is also conceivable that the outside of the non-ground communication coverage is the outside of the coverage of the ground base station device 60 (the outside of the ground communication coverage). As explained above, when the ground communication cannot be performed outside the non-ground communication coverage, the terminal device 40 can continue the communication outside the non-ground communication coverage by performing the side-link communication with another terminal device 40.

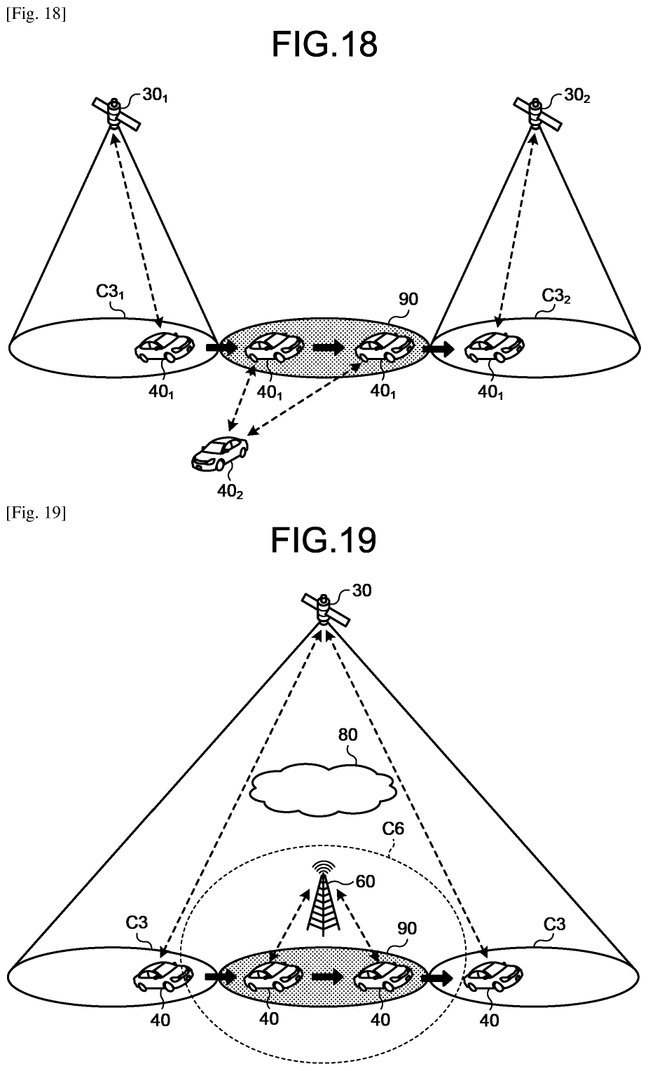

FIG. 18 is a diagram for explaining another example of the communication by the communication system 1 according to the embodiment of the present disclosure. In FIG. 18, the terminal device 40₁ performs the side-link communication with another terminal device 40₂ outside the coverage C3 of the base station device 30.

As illustrated in FIG. 18, when the terminal device 40₁ is located within the coverage C3₁ of the base station device 30₁, the terminal device 40₁ performs satellite communication with the base station device 30. At this time, the base station device 30₁ can collect terminal information from the terminal device 40. The base station device 30₁ uses the terminal information to determine, for example, when the terminal device 40 moves to the outside of the coverage C3₁ of the base station device 30₁.

When the terminal device 40 moves from the inside of the coverage C3₁ of the base station device 30₁ to the region 90 outside the coverage C3₁, the terminal device 40₁ performs the side-link communication (for example, V2V communication) with the other terminal device 40₂. The side-link communication between the terminal device 40 and the ground base station device 60 is non-satellite communication. As explained above, the terminal device 40 can perform communication with ensured reliability by performing the side-link communication outside the coverage C3₁ of the base station device 30₁.

Note that the side-link communication performed between the terminal device 40₁ and the other terminal device 40₂ is network non-assisted inter-device communication. As explained above, the terminal device 40₁ moves from the inside of the non-ground communication coverage to the outside of the coverage to transition from network assisted communication (the satellite communication) to the network non-assisted communication.

At this time, the base station device 30₁ may notify the terminal device 40₁ of the transition to the network non-assisted inter-device communication and information (an example of non-satellite communication information) necessary for the network non-assisted inter-device communication.

When receiving the non-satellite communication information from the base station device 30₁, the terminal device 40₁ executes the transition to the network non-assisted communication and inter-device communication based on the notified non-satellite communication information.

Note that, when transitioning to the network non-assisted inter-device communication, the base station device 30₁ may alert the terminal device 40₁ to transition to the network non-assisted inter-device communication. The terminal device 40₁ that has received the alert issues an alert indicating transition to the network non-assisted communication to a user (controller) who uses the terminal device 40₁ such as a driver.

Consequently, the user can learn that the terminal device 40₁ transitions to the network non-assisted communication.

After moving from the outside of the coverage C3₁ of the base station device 30₁ to the inside of the coverage C3₂ of the base station device 30₂, the terminal device 40₁ performs satellite communication with the base station device 30₂. At this time, it is desirable that the terminal device 40₁ immediately transition to the satellite communication with the base station device 30₂.

This is because the network non-assisted communication with the other terminal device 40₂ is performed outside the non-ground communication coverage. The terminal device 40₁ can perform the network assisted communication by transitioning to the satellite communication with the base station device 30₂ and can ensure more reliable communication.

Note that, when transitioning to the network assisted communication, the base station device 30₂ may alert the terminal device 40₁ to transition to the network assisted communication. The terminal device 40₁ that has received the alert issues an alert indicating transition to the network assisted communication to a user (controller) who uses the terminal device 40₁ such as a driver.

Consequently, the user can learn that the terminal device 40₁ transitions to the network assisted communication.

### Signaling Example

An example of signaling in which the terminal device 40 performs exchange with the base station device 30 and/or the ground base station device 60 when performing side-link communication with another terminal device 40 as non-satellite communication is explained.

Terminal information notified to the base station device 30 by the terminal device 40 can include the same information as terminal information in the case in which the terminal device 40 performs ground communication as non-satellite communication.

Non-satellite communication information notified to the terminal device 40 by the base station device 30 can include side-link information concerning side-link communication in addition to non-satellite communication information in the case in which the terminal device 40 performs ground communication as non-satellite communication. Side-link information can include at least one piece of the following information. However, the following information is an example and, besides the following information, information concerning an existing side-link necessary in side-link communication can also be included as side-link information.
Information concerning a communication resource pool
Information concerning communication resource selecting means
Information concerning resources such as a subcarrier interval and a slot length
Information concerning the number of times of repeated transmission
Information concerning a modulation scheme
Information concerning an error correction code
Information concerning Redundancy Version
Information concerning retransmission
Information concerning reservation resources
Information concerning Measurement
Information concerning a band in which side-link communication is implemented
Information concerning a reference signal transmitted in the side-link communication
Information concerning TDD configuration
Information concerning a synchronization signal used in the side-link communication
Information concerning transmission power
Information concerning transmission timing

As explained above, when the terminal device 40 performs the ground communication as the non-satellite communication, the base station device 30 may notify the terminal device 40 of the first HO information and the first trigger information as the non-satellite communication information. When the terminal device 40 performs the ground communication as the non-satellite communication, the base station device 30 may notify the side-link information concerning the side-link communication as the non-satellite communication information.

The satellite communication information notified to the terminal device 40 by the base station device 30 can include the same information as the satellite communication information in the case in which the terminal device 40 performs the ground communication as the non-satellite communication. The second terminal information notified to the base station device 30 by the terminal device 40 can include the same information as the second terminal information in the case in which the terminal device 40 performs the ground communication as the non-satellite communication.

### Communication Processing Example

When the terminal device 40₁ performs side-link communication with another terminal device 40₂ as non-satellite communication, notification processing executed in the communication system 1 can be performed in the same manner as the notification processing illustrated in FIG. 15 and FIG. 16. Handover processing can be performed in the same manner as the handover processing illustrated in FIG. 17 except that ground communication performed between the terminal device 40₁ and the ground base station device 60 in step S509 is replaced with side-link communication between the terminal device 40₁ and the other terminal device 40₂.

As explained above, when the terminal device 40₁ moves from the inside of the non-ground communication coverage to the outside of the coverage, the terminal device 40₁ performs the side-link communication between the terminal device 40₁ and the other terminal device 40₂. When the terminal device 40₁ moves from the outside of the non-ground communication coverage to the inside of the coverage, the terminal device 40₁ performs non-ground communication with the Target base station device.

At this time, the terminal device 40₁ performs, for example, side-link communication including the first handover with the other terminal device 40₂ using non-satellite communication information acquired from the Source base station device. The terminal device 40₁ performs, for example, non-ground communication including the second handover with the Target base station device by using satellite communication information acquired from the Source base station device.

Consequently, the terminal device 40₁ can ensure highly reliable communication even when the terminal device 40₁ moves from the inside of the non-ground communication coverage to the outside of the coverage or from the outside of the non-ground communication coverage to the inside of the coverage. The terminal device 40₁ can continue communication even if the outside of the non-ground communication coverage is the outside of the ground communication coverage and can ensure highly reliable communication.

### <4.2. Second Case>

<4.2.1. Case in which Communication is Continued by Ground Communication>

In the first case explained above, it is assumed that the base station device 30₁ that has performed the non-ground communication before moving from the inside of the non-ground communication coverage to the outside of the coverage and the base station device 30₂ that performs the non-ground communication after moving from the outside of the non-ground communication coverage to the inside of the coverage are different devices. However, the base station device 30 that has performed the non-ground communication before moving from the inside of the non-ground communication coverage to the outside of the coverage and the base station device 30 that performs the non-ground communication after moving from the outside of the non-ground communication coverage to the inside of the coverage may be the same device.

FIG. 19 is a diagram for explaining an example of a second case of the communication system 1 according to the embodiment of the present disclosure.

In the example illustrated in FIG. 19, the base station device 30 forms the coverage C3. The base station device 30 performs communication (satellite communication or non-terrestrial network) with the terminal device 40 within the coverage C3.

Here, as illustrated in FIG. 19, when the obstacle 80 (a cloud in the example illustrated in FIG. 19) is present, the region 90 to be outside the coverage of the base station device 30 appears. In the region 90, the terminal device 40 cannot perform satellite communication with the base station device 30.

In this case, after moving from the inside of the coverage C3 to the outside of the coverage C3 of the base station device 30, for example, the terminal device 40 continues communication by performing ground communication with the ground base station device 60.

After moving from the outside of the coverage C3 of the base station device 30 to the inside the coverage C3, for example, the terminal device 40 continues communication by performing non-ground communication with the base station device 30 again.

Consequently, the terminal device 40 can ensure more reliable communication.

### Signaling Example

In the second case, the base station device 30 and the terminal device 40 can exchange the following signaling information in addition to/instead of the signaling information exchanged in the first case.

The base station device 30 can notify the terminal device 40 of the following non-satellite communication information in addition to/instead of the non-satellite communication information notified to the terminal device 40 in the first case.

For example, the base station device 30 can notify, in advance, the terminal device 40 of, as non-satellite communication information, information until the terminal device 40 returns to the inside of the non-ground communication coverage. Based on the information, the terminal device 40 can perform an operation until returning to the non-ground communication coverage. For example, the base station device 30 may include the satellite communication information explained in the first case in the non-satellite communication information and notify the terminal device 40 of the satellite communication information.

The base station device 30 may notify the terminal device 40 of information concerning a position where and a time when the terminal device 40 moves to the outside of the non-ground communication coverage. From this information, the terminal device 40 may estimate, for example, from which position to which position the outside of the non-ground communication coverage is or for how long time the terminal device 40 moves to the outside of the non-ground communication coverage.

For example, the non-satellite communication information notified from the base station device 30 to the terminal device 40 includes at least one piece of the following information. The non-satellite communication information is, for example, information concerning implementation of temporary movement to the outside of temporary non-ground communication coverage.
Information concerning immediate movement
Timer information until movement implementation
Information concerning received power (RSRP information, RSRQ information, RSSI information, and the like)

For example, the satellite communication information notified from the base station device 30 to the terminal device 40 includes at least one piece of the following information. The satellite communication information is, for example, information concerning a trigger for performing movement to the inside of the non-ground communication coverage.
Information concerning received power (RSRP information, RSRQ information, RSSI information, and the like)
Timer information
Information concerning time
Information concerning implementation start time of a trigger detection operation
Information concerning an operation after the timer expires
Information concerning a surrounding environment

Note that the information concerning the surrounding environment can include, for example, map information, tunnel brightness information, weather information, and rain cloud information.

### Communication Processing Example

A communication process example in which the communication system 1 continues communication by performing ground communication outside the non-ground communication coverage in the second case is explained. Note that notification processing is the same as the notification processing in the first case (see FIG. 15 and FIG. 16).

### (Movement Processing)

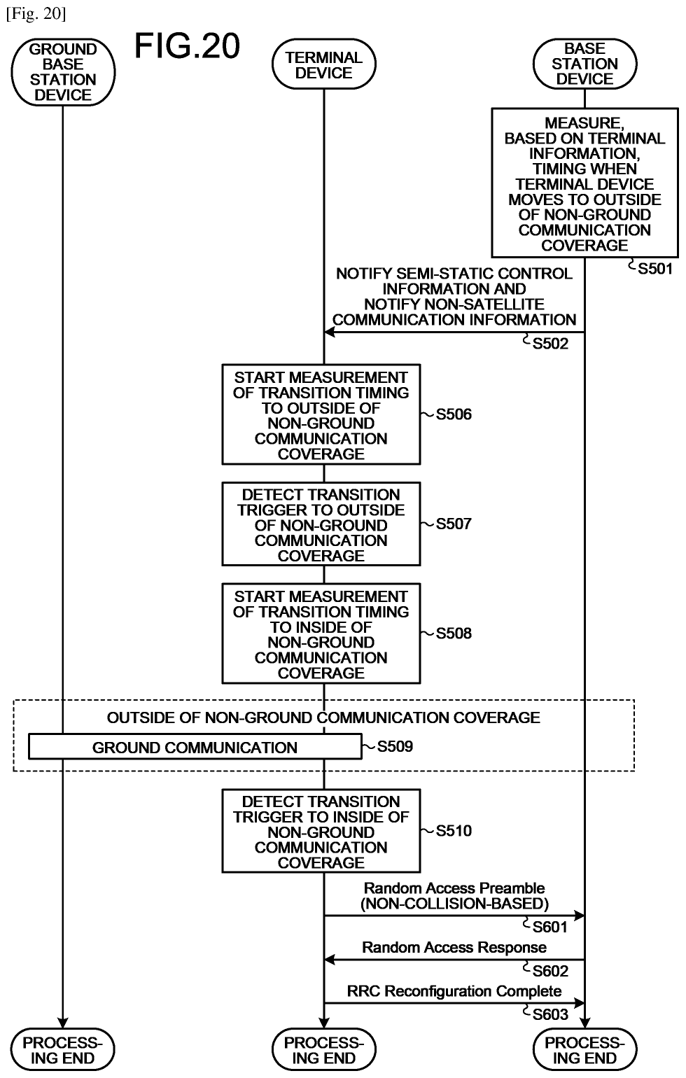

FIG. 20 is a sequence chart illustrating an example of a flow of movement processing according to the embodiment of the present disclosure. The movement processing illustrated in FIG. 20 includes movement from the inside of the non-ground communication coverage to the outside of the coverage and movement from the outside of the non-ground communication coverage to the inside of the coverage. Note that, in the processing illustrated in FIG. 20, the same processing as the handover processing illustrated in FIG. 17 is denoted by the same reference sign and explanation of the processing is omitted.

The terminal device 40 that has detected the transition trigger to the inside of the non-ground communication coverage in step S510 starts communication (satellite communication) in the non-ground communication coverage.

The terminal device 40 transmits a Random Access Preamble to the base station device 30 (step S601). The terminal device 40 transmits, for example, a non-collision-based Random Access Preamble to the base station device 30. The terminal device 40 transmits the Random Access Preamble to the base station device 30 that has been performing communication before moving from the inside of the non-ground communication coverage to the outside of the coverage.

The base station device 30 transmits a Random Access Response to the terminal device 40 (step S602). The terminal device 40 transmits RRC Reconfiguration Complete to the base station device 30 (step S603).

Thereafter, the terminal device 40 resumes satellite communication with the base station device 30.

As explained above, when the terminal device 40 moves from the inside of the non-ground communication coverage to the outside of the coverage, the terminal device 40 performs ground communication with the ground base station device 60. When the terminal device 40 moves from the outside of the non-ground communication coverage to the inside of the coverage, the terminal device 40 resumes non-ground communication with the base station device 30.

At this time, the terminal device 40 performs, for example, ground communication including the first handover with the ground base station device 60 using non-satellite communication information acquired from the base station device 30. In addition, the terminal device 40 performs, for example, non-ground communication including the second handover with the base station device 30 using satellite communication information acquired from the base station device 30 and/or the ground base station device 60.

As a result, the terminal device 40 can ensure highly reliable communication even when moving from the inside of the non-ground communication coverage to the outside of the coverage or from the outside of the non-ground communication coverage to the inside of the coverage.

### <4.2.2. When Communication is Continued by the Side-Link Communication>

In the second case, as in the first case explained above, the terminal device 40 can perform the side-link communication instead of the ground communication outside the non-ground communication coverage.

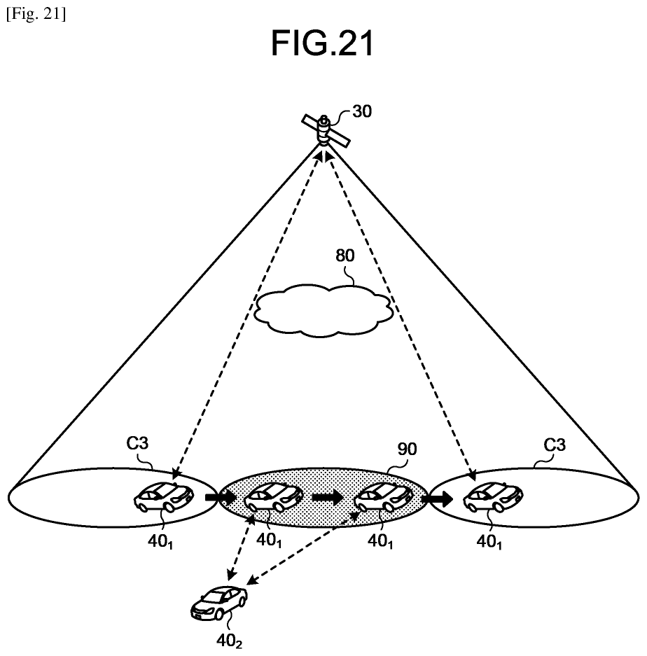

FIG. 21 is a diagram for explaining another example of the second case of the communication system 1 according to the embodiment of the present disclosure.

In the example illustrated in FIG. 21, the region 90 that is out of the coverage appears. In the region 90, the terminal device 40₁ cannot perform satellite communication with the base station device 30. Furthermore, in the example of FIG. 21, the region 90 is outside the coverage (the ground communication coverage) of the ground base station device 60. Therefore, in the region 90, the terminal device 40₁ cannot perform ground communication with the ground base station device 60.

In this case, after moving from the inside of the coverage C3 to the outside of the coverage C3 of the base station device 30, the terminal device 40₁ continues communication, for example, by performing the side-link communication with another terminal device 40₂.

After moving from the outside of the coverage C3 of the base station device 30 to the inside of the coverage C3, the terminal device 40₁ continues communication, for example, by performing non-ground communication with the base station device 30 again.

Consequently, the terminal device 40₁ can ensure more reliable communication.

### Signaling Example

In the second case, when communication is continued by the side-link communication, the base station device 30 and the terminal device 40 can exchange the same signaling information as the signaling information in the case in which communication is continued by the ground communication in the first case and the second case.

### Communication Processing Example

A communication processing example in which the communication system 1 continues communication by performing the side-link communication outside the non-ground communication coverage in the second case is explained. Note that notification processing is the same as the notification processing in the first case (see FIG. 15 and FIG. 16).

### (Movement Processing)

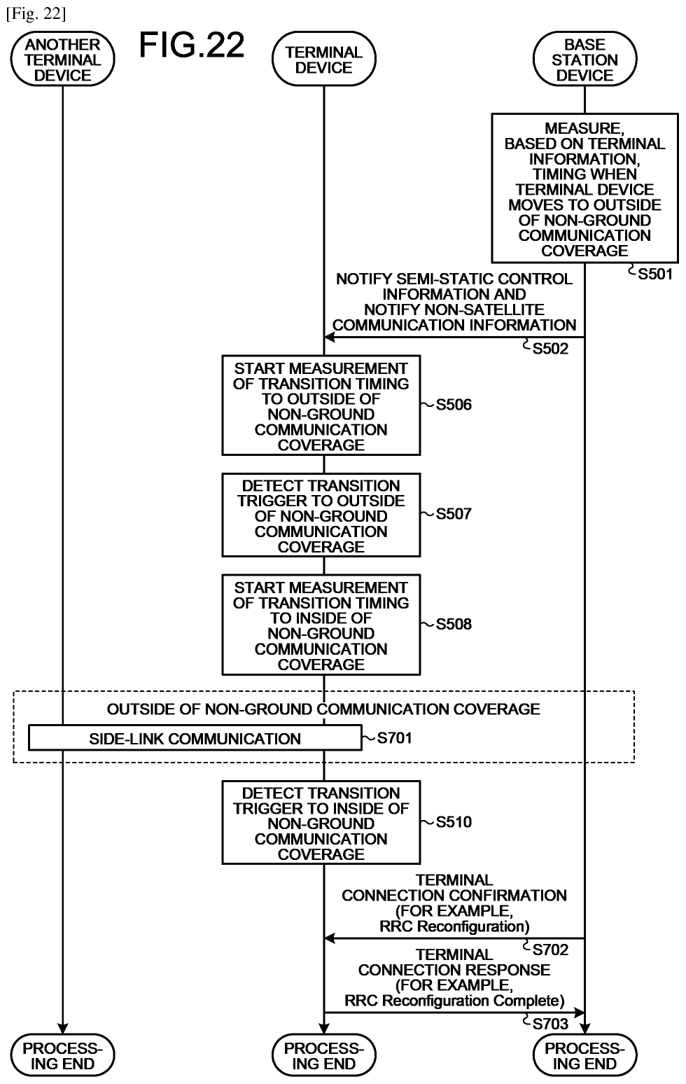

FIG. 22 is a sequence chart illustrating an example of a flow of movement processing according to the embodiment of the present disclosure. The movement processing illustrated in FIG. 22 includes movement from the inside of the non-ground communication coverage to the outside of the coverage and movement from the outside of the non-ground communication coverage to the inside of the coverage. Note that, in the processing illustrated in FIG. 20, the same processing as the handover processing illustrated in FIG. 17 is denoted by the same reference sign and explanation of the processing is omitted.

The terminal device 40₁ that has detected the transition trigger to the outside of the non-ground communication coverage in step S507 starts measuring transition timing to the inside of the non-ground communication coverage (step S508). The terminal device 40₁ starts side-link communication outside the non-ground communication coverage with another terminal device 40₂ (step S701).

The terminal device 40₁ that has detected the transition trigger to the inside of the non-ground communication coverage in step S510 starts communication (satellite communication) in the non-ground communication coverage.

For example, the base station device 30 performs terminal connection confirmation (step S702). The base station device 30 transmits, for example, RRC Reconfiguration to the terminal device 40₁. The base station device 30 performs a terminal connection response (step S703). The terminal device 40₁ transmits, for example, RRC Reconfiguration Complete to the base station device 30.

Thereafter, the terminal device 40₁ resumes satellite communication with the base station device 30.

As explained above, when the terminal device 40₁ moves from the inside of the non-ground communication coverage to the outside of the coverage, the terminal device 40₁ performs the side-link communication with the other terminal device 40₂. When the terminal device 40₁ moves from the outside of the non-ground communication coverage to the inside of the coverage, the terminal device 40₁ resumes non-ground communication with the base station device 30.

At this time, the terminal device 40₁ performs, for example, side-link communication including the first handover with the other terminal device 40₂ using the non-satellite communication information acquired from the base station device 30. The terminal device 40₁ performs, for example, non-ground communication including the second handover with the base station device 30 using the satellite communication information acquired from the base station device 30.

Consequently, the terminal device 40₁ can ensure highly reliable communication even when the terminal device 40₁ moves from the inside of the non-ground communication coverage to the outside of the coverage or from the outside of the non-ground communication coverage to the inside of the coverage.

### 5. OTHER EMBODIMENTS

MDT (Minimization of Driving Test) can be performed using the communication system 1 explained above.

For example, in a wireless communication network, optimization of a network is performed by placing the terminal device 40 and a testing machine on a mobile body such as a car and collecting data concerning the network. The optimization is called drive test as well.

Since this drive test requires time and cost, a network operator has a request for reducing the burden of the drive test. Therefore, a purpose of the MDT includes reducing or eliminating the drive test by collecting necessary data (Measurement) from the terminal device 40.

The communication system 1 according to the embodiment of the present disclosure can be applied in the MDT. For example, the terminal device 40 notifies the base station device 30 of the terminal information explained above (for example, position information of the terminal device, speed information of the terminal device, information concerning mobility such as a moving direction, sensing information of the terminal device, and information concerning a terminal state of the terminal device). The base station device 30 can optimize a network by using the notified information.

At this time, the terminal device 40 may include presence or absence of ability to collect information to be collected by the MDT and availability of information provision in the Capability information (terminal Capability) of terminal and notify the base station device 30 of the presence or absence of ability to collect information and the availability of information provision.

The base station device 30 may implement network optimization and communication control based on the information notified from the terminal device 40.

### 6. MODIFICATIONS

The embodiment explained above indicate an example and various changes and applications are possible.

For example, in the embodiment explained above, the terminal device 40 communicates with the ground station 20 via the satellite station 30. However, the terminal device 40 may communicate with the ground station 20 via an aircraft station. In this case, the satellite station 30 appearing in the embodiment explained above may be read as aircraft station. Besides, the satellite station 30 appearing in the embodiment explained above can be read as non-ground station (non-ground base station).

The terminal device 40 may communicate with the ground station 20 via a ground station (a ground base station). In this case, the satellite station 30 appearing in the embodiment explained above may be read as ground station. The ground station may include a terminal device. Besides, the satellite station 30 appearing in the embodiment explained above can be read as base station, terminal device, or relay station.

A control device that controls the management device 10, the ground station 20, the satellite station 30, and the terminal device 40 in the present embodiment may be realized by a dedicated computer system or a general-purpose computer system.

For example, a communication program for executing the operation explained above is distributed by being stored in a computer-readable recording medium such as an optical disk, a semiconductor memory, a magnetic tape, or a flexible disk. Then, for example, the program is installed in a computer and the control device is configured by executing the processing explained above. At this time, the control device may be a device (for example, a personal computer) on the outside of the management device 10, the ground station 20, the satellite station 30, and the terminal device 40. The control device may be a device (for example, the control unit 13, the control unit 23, the control unit 33, and the control unit 43) on the inside of the management device 10, the ground station 20, the satellite station 30, and the terminal device 40.

The communication program explained above may be stored in a disk device included in a server device on a network such as the Internet such that the communication program can be downloaded to a computer. The functions explained above may be realized by cooperation of an OS (Operating System) and application software. In this case, a portion other than the OS may be stored in a medium and distributed or a portion other than the OS may be stored in the server device and downloaded to the computer.

Among the processing explained in the embodiment, all or a part of the processing explained as being automatically performed can be manually performed or all or a part of the processing explained as being manually performed can be automatically performed by a known method. Besides, the processing procedure, the specific names, and the information including the various data and parameters explained in the document and illustrated in the drawings can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like.

The embodiments explained above can be combined as appropriate in a range for not causing the processing contents to contradict one another. Furthermore, the order of the steps illustrated in the flowchart of the embodiment explained above can be changed as appropriate.

For example, the present embodiment can be realized as any component configuring a device or a system, for example, a processor functioning as a system LSI (Large Scale Integration) or the like, a module that uses a plurality of processors or the like, a unit that uses a plurality of modules or the like, or a set obtained by further adding other functions to the unit (that is, a component as a part of the device).

Note that, in the present embodiment, the system means a set of a plurality of components (devices, modules (parts), and the like) It does not matter whether all the components are present in the same housing. Therefore, both of a plurality of devices housed in separate housings and connected via a network and one device in which a plurality of modules are housed in one housing are systems.

For example, the present embodiment can adopt a configuration of cloud computing in which one function is shared and processed by a plurality of devices in cooperation via a network.

### 7. CONCLUSION

Although the embodiments of the present disclosure explained above, the technical scope of the present disclosure is not limited to the embodiments per se. Various changes can be made without departing from the gist of the present disclosure. Components in different embodiments and modifications may be combined as appropriate.

The effects in the embodiments explained in this specification are only illustrations and are not limited. Other effects may be present.

Note that the present technique can also take the following configurations.

(1)

An electronic device comprising:

circuitry configured to
receive, from a first non-terrestrial base station, terrestrial communication information for performing terrestrial communication outside of a coverage area of the first non-terrestrial base station;
receive, from the first non-terrestrial base station, non-terrestrial communication information for performing non-terrestrial communication with the first non-terrestrial base station or a second non-terrestrial base station;
perform the terrestrial communication using the terrestrial communication information in a case that the electronic device moves from inside to outside the coverage area of the first non-terrestrial base station; and
perform the non-terrestrial communication using the non-terrestrial communication information in a case that the electronic device moves from outside to inside the coverage area of the first non-terrestrial base station or from outside to inside a coverage area of the second non-terrestrial base station.
   (2)

The electronic device of (1), wherein

the circuitry is configured to perform the terrestrial communication with a terrestrial base station based on the terrestrial communication information in the case that the electronic device moves from inside to outside the coverage area of the first non-terrestrial base station.

(3)

The electronic device of any of (1) to (2), wherein

the terrestrial communication information includes at least one of
information corresponding to handover to a terrestrial base station,
information corresponding to detachment from the first non-terrestrial base station, and
information corresponding to a next and subsequent handover destinations.
   (4)

The electronic device of any of (1) to (3), wherein

the circuitry is configured to perform side-link communication with another electronic device as the terrestrial communication using the terrestrial communication information in the case that that the electronic device moves from inside to outside the coverage area of the first non-terrestrial base station.

(5)

The electronic device of (4), wherein

the terrestrial communication information includes information for performing the side-link communication.

(6)

The electronic device of any of (1) to (5), wherein

the terrestrial communication information includes information corresponding to a movement trigger from inside to outside the coverage area of the first non-terrestrial base station.

(7)

The electronic device of (6), wherein

the information corresponding to the movement trigger includes at least one of
threshold information corresponding to received power in the coverage area of the first non-terrestrial base station,
information corresponding to a timer for implementing movement from inside to outside the coverage area of the first non-terrestrial base station,
information corresponding to time for implementing movement from inside to outside the coverage area of the first non-terrestrial base station, and
information corresponding to execution of movement from inside to outside the coverage area of the first non-terrestrial base station.
   (8)

The electronic device of any of (1) to (7), wherein

the circuitry is configured to perform the non-terrestrial communication with the second non-terrestrial base station in a case that the electronic device moves from outside to inside the coverage area of the second non-terrestrial base station.

(9)

The electronic device of (8), wherein

the circuitry is configured to receive the non-terrestrial communication information from a terrestrial base station that performs the terrestrial communication outside the coverage area of the first non-terrestrial base station.

(10)

The electronic device of (8), wherein

the second non-terrestrial base station is the first non-terrestrial base station.

(11)

The electronic device of (10), wherein

the non-satellite communication information includes information corresponding to a movement trigger to outside the coverage area of the first non-terrestrial base station.

(12)

The electronic device of (11), wherein

the information corresponding to the movement trigger includes at least one of information corresponding to immediate movement, timer information until movement implementation, and information corresponding to received power.

(13)

The electronic device of (10), wherein

the non-terrestrial communication information includes information corresponding to a movement trigger to inside the coverage of the second non-terrestrial base station.

(14)

The electronic device of (13), wherein

the information corresponding to the movement trigger includes at least one of information corresponding to received power, timer information, time information, information corresponding to implementation start time of a trigger detection operation, information corresponding to an operation after a timer end, and surrounding environment information.

(15)

The electronic device of any of (8) to (15), wherein

the second non-terrestrial base station is different from the first non-terrestrial base station.

(16)

The electronic device of (15), wherein

the second non-terrestrial base station acquires, from the first non-terrestrial base station, inter-satellite information used in the non-terrestrial communication when the electronic device moves inside the coverage of the second non-terrestrial base station.

(17)

The electronic device of any of (1) to (16), wherein

the circuitry is configured to transmit terminal information to the first non-terrestrial base station, the terminal information being used to estimate a timing of the electronic device moving outside the coverage area of the first non-terrestrial base station.

(18)

The electronic device of any of (1) to (17), wherein

the first non-terrestrial base station is a first satellite base station, and the second non-terrestrial base station is a second satellite base station.

(19)

A method performed by an electronic device, the method comprising:

receiving, from a first non-terrestrial base station, terrestrial communication information for performing terrestrial communication outside of a coverage area of the first non-terrestrial base station;

receiving, from the first non-terrestrial base station, non-terrestrial communication information for performing non-terrestrial communication with the first non-terrestrial base station or a second non-terrestrial base station;

performing the terrestrial communication using the terrestrial communication information in a case that the electronic device moves from inside to outside the coverage area of the first non-terrestrial base station; and

performing the non-terrestrial communication using the non-terrestrial communication information in a case that the electronic device moves from outside to inside the coverage area of the first non-terrestrial base station or the second non-terrestrial base station.

(20)

A terminal device configured for use in a wireless communications system, the terminal device comprising:

circuitry configured to
receive, from a first satellite base station, first communication information for performing communication with a terrestrial base station outside a coverage area of the first satellite base station;
receive, from the first satellite base station, second communication information for performing satellite communication with a second satellite base station, which is different from the first satellite base station;
communicate with the terrestrial base station using the first communication information upon determining that the terminal device has moved from inside to outside the coverage area of the first satellite base station; and
communicate with the second satellite base station using the second communication information upon determining that the terminal device has moved from outside to inside a coverage area of the second satellite base station.
   (21)

A non-terrestrial base station configured for use in a wireless communications system, the non-terrestrial base station comprising:

circuitry configured to
transmit, to a terminal device, terrestrial communication information for performing terrestrial communication outside of a coverage area of the non-terrestrial base station, the terrestrial communication information including control information for the terminal device to perform handover to a terrestrial base station in the case that the terminal device moves from inside to outside the coverage area of the non-terrestrial base station; and
transmit, to the terminal device, non-terrestrial communication information for performing non-terrestrial communication with a second non-terrestrial base station, the non-terrestrial communication information including control information to perform handover to a second non-terrestrial base station in a case that the terminal device moves from outside to inside a coverage area of the second non-terrestrial base station.
   (22)

A method performed by a non-terrestrial base station configured for use in a wireless communications system, the method comprising:

transmitting, to a terminal device, terrestrial communication information for performing terrestrial communication outside of a coverage area of the non-terrestrial base station, the terrestrial communication information including control information for the terminal device to perform handover to a terrestrial base station in the case that the terminal device moves from inside to outside the coverage area of the non-terrestrial base station; and

transmitting, to the terminal device, non-terrestrial communication information for performing non-terrestrial communication with a second non-terrestrial base station, the non-terrestrial communication information including control information to perform handover to a second non-terrestrial base station in a case that the terminal device moves from outside to inside a coverage area of the second non-terrestrial base station.

### REFERENCE SIGNS LIST

1 Communication system
10 Management device
20 Ground station
30, 50 Satellite station
40 Terminal device
60 Ground base station device
70 Aircraft station
11 Communication unit
21, 31, 41 Wireless communication unit
12, 22, 32, 42 Storage unit
13, 23, 33, 43 Control unit

1. An electronic device comprising:
circuitry configured to
receive, from a first non-terrestrial base station, terrestrial communication information for performing terrestrial communication outside of a coverage area of the first non-terrestrial base station;
receive, from the first non-terrestrial base station, non-terrestrial communication information for performing non-terrestrial communication with the first non-terrestrial base station or a second non-terrestrial base station;
perform the terrestrial communication using the terrestrial communication information in a case that the electronic device moves from inside to outside the coverage area of the first non-terrestrial base station; and
perform the non-terrestrial communication using the non-terrestrial communication information in a case that the electronic device moves from outside to inside the coverage area of the first non-terrestrial base station or from outside to inside a coverage area of the second non-terrestrial base station.

2. The electronic device of claim 1, wherein
the circuitry is configured to perform the terrestrial communication with a terrestrial base station based on the terrestrial communication information in the case that the electronic device moves from inside to outside the coverage area of the first non-terrestrial base station.

3. The electronic device of claim 1, wherein
the terrestrial communication information includes at least one of
information corresponding to handover to a terrestrial base station,
information corresponding to detachment from the first non-terrestrial base station, and
information corresponding to a next and subsequent handover destinations.

4. The electronic device of claim 1, wherein
the circuitry is configured to perform side-link communication with another electronic device as the terrestrial communication using the terrestrial communication information in the case that that the electronic device moves from inside to outside the coverage area of the first non-terrestrial base station.

5. The electronic device of claim 4, wherein
the terrestrial communication information includes information for performing the side-link communication.

6. The electronic device of claim 1, wherein
the terrestrial communication information includes information corresponding to a movement trigger from inside to outside the coverage area of the first non-terrestrial base station.

7. The electronic device of claim 6, wherein
the information corresponding to the movement trigger includes at least one of
threshold information corresponding to received power in the coverage area of the first non-terrestrial base station,
information corresponding to a timer for implementing movement from inside to outside the coverage area of the first non-terrestrial base station,
information corresponding to time for implementing movement from inside to outside the coverage area of the first non-terrestrial base station, and
information corresponding to execution of movement from inside to outside the coverage area of the first non-terrestrial base station.

8. The electronic device of claim 1, wherein
the circuitry is configured to perform the non-terrestrial communication with the second non-terrestrial base station in a case that the electronic device moves from outside to inside the coverage area of the second non-terrestrial base station.

9. The electronic device of claim 8, wherein
the circuitry is configured to receive the non-terrestrial communication information from a terrestrial base station that performs the terrestrial communication outside the coverage area of the first non-terrestrial base station.

10. The electronic device of claim 8, wherein
the second non-terrestrial base station is the first non-terrestrial base station.

11. The electronic device of claim 10, wherein
the non-satellite communication information includes information corresponding to a movement trigger to outside the coverage area of the first non-terrestrial base station.

12. The electronic device of claim 11, wherein
the information corresponding to the movement trigger includes at least one of information corresponding to immediate movement, timer information until movement implementation, and information corresponding to received power.

13. The electronic device of claim 10, wherein
the non-terrestrial communication information includes information corresponding to a movement trigger to inside the coverage of the second non-terrestrial base station.

14. The electronic device of claim 13, wherein
the information corresponding to the movement trigger includes at least one of information corresponding to received power, timer information, time information, information corresponding to implementation start time of a trigger detection operation, information corresponding to an operation after a timer end, and surrounding environment information.

15. The electronic device of claim 8, wherein
the second non-terrestrial base station is different from the first non-terrestrial base station.

16. The electronic device of claim 15, wherein
the second non-terrestrial base station acquires, from the first non-terrestrial base station, inter-satellite information used in the non-terrestrial communication when the electronic device moves inside the coverage of the second non-terrestrial base station.

17. The electronic device of claim 1, wherein
the circuitry is configured to transmit terminal information to the first non-terrestrial base station, the terminal information being used to estimate a timing of the electronic device moving outside the coverage area of the first non-terrestrial base station.

18. The electronic device of claim 1, wherein
the first non-terrestrial base station is a first satellite base station, and the second non-terrestrial base station is a second satellite base station.

19. A method performed by an electronic device, the method comprising:
receiving, from a first non-terrestrial base station, terrestrial communication information for performing terrestrial communication outside of a coverage area of the first non-terrestrial base station;
receiving, from the first non-terrestrial base station, non-terrestrial communication information for performing non-terrestrial communication with the first non-terrestrial base station or a second non-terrestrial base station;
performing the terrestrial communication using the terrestrial communication information in a case that the electronic device moves from inside to outside the coverage area of the first non-terrestrial base station; and
performing the non-terrestrial communication using the non-terrestrial communication information in a case that the electronic device moves from outside to inside the coverage area of the first non-terrestrial base station or the second non-terrestrial base station.

20. A terminal device configured for use in a wireless communications system, the terminal device comprising:
circuitry configured to
receive, from a first satellite base station, first communication information for performing communication with a terrestrial base station outside a coverage area of the first satellite base station;
receive, from the first satellite base station, second communication information for performing satellite communication with a second satellite base station, which is different from the first satellite base station;
communicate with the terrestrial base station using the first communication information upon determining that the terminal device has moved from inside to outside the coverage area of the first satellite base station; and
communicate with the second satellite base station using the second communication information upon determining that the terminal device has moved from outside to inside a coverage area of the second satellite base station.

21. A non-terrestrial base station configured for use in a wireless communications system, the non-terrestrial base station comprising:
circuitry configured to
transmit, to a terminal device, terrestrial communication information for performing terrestrial communication outside of a coverage area of the non-terrestrial base station, the terrestrial communication information including control information for the terminal device to perform handover to a terrestrial base station in the case that the terminal device moves from inside to outside the coverage area of the non-terrestrial base station; and
transmit, to the terminal device, non-terrestrial communication information for performing non-terrestrial communication with a second non-terrestrial base station, the non-terrestrial communication information including control information to perform handover to a second non-terrestrial base station in a case that the terminal device moves from outside to inside a coverage area of the second non-terrestrial base station.

22. A method performed by a non-terrestrial base station configured for use in a wireless communications system, the method comprising:
transmitting, to a terminal device, terrestrial communication information for performing terrestrial communication outside of a coverage area of the non-terrestrial base station, the terrestrial communication information including control information for the terminal device to perform handover to a terrestrial base station in the case that the terminal device moves from inside to outside the coverage area of the non-terrestrial base station; and
transmitting, to the terminal device, non-terrestrial communication information for performing non-terrestrial communication with a second non-terrestrial base station, the non-terrestrial communication information including control information to perform handover to a second non-terrestrial base station in a case that the terminal device moves from outside to inside a coverage area of the second non-terrestrial base station.
